(19) United States
(12) Patent Application Publication
(10) Pub. No.: US 2009/0241577 A1
(43) Pub. Date: Oct. 1, 2009

(54) Chiller unit, refrigeration system having chiller unit and air conditioner having chiller unit

(75) Inventors: Michio Fukushima, Ora-gun (JP); Hideki Fujikawa, Honjo-shi (JP); Shigeru Yoshii, Ora-gun (JP); Satoru Kanazawa, Gyoda-shi (JP)

Correspondence Address: OLIFF & BERRIDGE, PLC, P.O. BOX 320850, ALEXANDRIA, VA, 22320-4850, US

(73) Assignee: SANYO ELECTRIC CO., LTD., Moriguchi-shi (JP)

(21) Appl. No.: 12/382,476

(22) Filed: Mar. 17, 2009

(30) Foreign Application Priority Data
Mar. 26, 2008 (JP) 2008-079696
Mar. 27, 2008 (JP) 2008-082626
Mar. 27, 2008 (JP) 2008-082627

(51) Int. Cl. F25D 23/00; F28F 3/08; G05D 23/00; G05B 15/00

(52) U.S. Cl. 62/259.1; 165/166; 165/288; 700/275

(57) ABSTRACT

A chiller unit including a chiller unit main body connected to a refrigeration cycle, a plate type heat exchanger unit that is secured to an upper stage portion of the chiller unit main body and divided into plural plate type heat exchangers, and a pipe group having a water medium pipe and a refrigerant pipe for supplying water medium and refrigerant to each of the plate type heat exchangers while branching the water medium and the refrigerant and collectively disposed at a lower stage portion of the chiller unit main body, wherein at least an exit side portion of the water medium pipe is routed substantially horizontally along the bottom portion of the chiller unit main body and a flow switch is provided in a horizontally-extending pipe portion of the water medium pipe.

### INCORPORATION BY REFERENCE

The present application claims priority under 35 U.S.C. §119 to Japanese Patent Application No. 2008-079696 filed on Mar. 26, 2008, Japanese Patent Application No. 2008-082626 filed on Mar. 27, 2008 and Japanese Patent Application No. 2008-082627 filed on Mar. 27, 2008. The content of the applications is incorporated herein by reference in its entirety.

### BACKGROUND OF THE INVENTION

1. Field of the Invention

The present invention relates to a chiller unit (apparatus) having a heat exchanger for performing the heat exchange between refrigerant and water medium, a refrigeration system having the chiller unit and an air conditioner having the chiller unit.

2. Description of the Related Art

A chiller unit (apparatus) having a chiller unit main body connected to a refrigeration cycle is generally known (for example, JP-A-2004-251486). In this type of chiller unit, plural divided plate type heat exchangers are secured to the bottom portion of the chiller unit main body, and a pipe group comprising plural pipes used to branch flow of each of refrigerant and water medium and supply the branched flows of the refrigerant the water medium to the respective heat exchangers is routed in the chiller unit main body so as to extend to the respective heat exchangers.

In the chiller unit, water medium is excessively cooled and frozen in a heat exchanger. When the chiller unit is actuated under the state that the water medium is frozen, a water medium pipe or a pump for making water medium flow may be damaged.

In order to prevent this damage, a paddle type flow switch for detecting freezing of water medium may be externally equipped to a water medium pipe at the outside of the chiller unit. When the flow switch detects freezing of water medium, the operation of the refrigeration cycle is stopped.

In this type of chiller unit, it is required to perform a work of externally quipping a flow switch for detecting freeze to a predetermined position of a water medium pipe connected to the chiller unit after the chiller unit is installed outdoors, and also it is required to perform various adjustments of the flow switch, so that much labor is required to the works associated with the installation of the chiller unit.

Furthermore, when the flow switch is provided in the chiller unit, maintenance of the flow switch is difficult because the plural divisional plate type heat exchangers and the pipe group for splitting refrigerant and water medium are laid down at the bottom portion of the chiller unit main body.

The flow switch easily carries out false detection due to vibration. Therefore, when the flow switch is provided in the chiller unit, it is easily affected by vibration of a compressor or the like constituting a refrigeration cycle which is disposed adjacently to the chiller unit, which easily induces false detection of flow in the water medium pipe.

Furthermore, there is also known a chiller unit in which water flow is detected by a flow switch and abnormality of a pump is detected on the basis of the detection result of the flow switch. In the case of this chiller unit, when this flow switch is provided in the water medium pipe and the abnormality of the pump is detected by the flow switch, an outdoor unit and the pump is controlled to stop the operation thereof. In some situations, plural chiller units are connected to one outdoor unit in parallel. In this case, a more effective connection style of connecting a water medium pipe as a single-path system or connecting a water medium pipe as a multipath system(i.e., the water medium pipe is divided into multiple paths) is selected. However, when the water medium pipe is connected as the single-path system, the outdoor unit is controlled to stop when all the flow switches operate. When the water medium pipe is connected as the multipath system, the outdoor unit is controlled to stop when at least one of the flow switches operates.

The selection of the connection style of the water medium pipe cannot be determined at the factory shipment time, and it must be performed by an on-site work containing an electric wiring work, etc.

Furthermore, in the chiller unit as described above, the heat exchanger has a high heat exchange efficiency, however, when water circulating in the chiller unit is frozen, the chiller unit itself must be set to thermo-off to eliminate the freeze. In the prior art, when the refrigerant temperature is reduced to minus 10° C., the chiller unit is set to thermo-off. There is a case where the chiller unit is connected to the outdoor unit and further one or plural direct-expansion type indoor units are connected to the chiller unit in parallel. In this case, the direct-expansion indoor units perform individual air-conditioning, and the space to be air-conditioned is not uniform. Accordingly, the thermo-on and thermo-off of the direct-expansion indoor unit are repeated in accordance with the relationship between the room temperature and the set temperature, so that rapid load variation may occur.

In the above construction, when the load of the direct-expansion indoor unit rapidly varies, refrigerant excessively flows into the chiller unit, and the refrigerant temperature temporarily reaches minus 10° C. Therefore, it may happen that the chiller unit is immediately set to thermo-off. This phenomenon is a frequently-occurring transient phenomenon, and if the chiller unit is set to thermo-off every time this phenomenon occurs, it would be impossible to smoothly generate cold/hot water.

Furthermore, in the above construction, when a required load of the chiller unit is large, the circulation amount of refrigerant is increased even if the load of the direct-expansion indoor unit is small. In this case, when a large amount of refrigerant flows into the direct-expansion indoor unit, drain is frozen between the fins of the heat exchanger of the direct-expansion indoor unit, and thus the air flow amount therebetween is reduced, so that the air conditioning operation cannot be smoothly performed.

### SUMMARY OF THE INVENTION

The present invention has been implemented in view of the foregoing situation, and has an object to provide a chiller unit which can reduce a labor imposed on a work associated with installation of the chiller unit, can substantially accurately detect the flow of water medium in a water medium pipe by a flow switch and enhance the maintenance performance of the flow switch.

The present invention has another object to provide a refrigeration system having a chiller unit which can simply perform an on-site installation work containing a electrical wiring work even when a single-system water medium pipe is connected or multi-system water medium pipes are connected in a case where plural chiller units are connected to an outdoor unit in parallel.

Furthermore, the present invention has other object to provide an air conditioner in which a direct-expansion indoor unit and a chiller unit are connected to an outdoor unit in parallel and which can prevent freeze of water therein and perform smooth air-conditioning operation.

In order to attain the above objects, according to a first aspect of the present invention, there is provided a chiller unit comprising: a chiller unit main body connected to a refrigeration cycle; a plate type heat exchanger unit that is secured to an upper stage portion of the chiller unit main body and divided into plural plate type heat exchangers; and a pipe group having a water medium pipe and a refrigerant pipe for supplying water medium and refrigerant to each of the plate type heat exchangers while branching the water medium and the refrigerant and collectively disposed at a lower stage portion of the chiller unit main body, wherein at least an exit side portion of the water medium pipe is routed substantially horizontally along the bottom portion of the chiller unit main body and a flow switch is provided in a horizontally-extending pipe portion of the water medium pipe.

In the above chiller unit, the substantially horizontally extending pipe portion may be fixed to the bottom portion of the chiller unit main body through a fixing member, and the flow switch may be provided to the pipe portion in the neighborhood of the fixing member.

In the above chiller unit, the chiller unit main body may have a support table substantially at the center portion in the height direction thereof, and the plate type heat exchangers may be mounted to side portions of the chiller unit main body through support plates.

In the above chiller unit, the respective plate type heat exchangers may be secured to the confronting side portions of the chiller unit main body so that an overall weight balance of the chiller unit main body is kept.

In the above chiller unit, the flow switch may comprise a paddle type flow switch having a paddle extending in a direction perpendicular to the flow direction of the water medium in the pipe portion.

According to a second aspect of the present invention, there is provided a refrigeration system comprising: an outdoor unit; plural chiller units which are connected to the outdoor unit in parallel and supplied with refrigerant through a refrigerant pipe and with water medium through at least single-system water medium pipe, each of the chiller units having a flow switch; a first unit for stopping the outdoor unit when at least one of the flow switches operates in the case where the plural chiller units are grouped into plural systems and connected to water medium pipes of plural systems; a second unit for stopping the outdoor unit when all the flow switches operate in the case where the chiller unit is connected to a single-system water medium pipe; and a selecting unit for alternatively selecting one of the first unit and the second unit on the basis of the connection relationship between the chiller unit and the water medium pipe.

In the above refrigeration system, the first unit, the second unit and the selecting unit may be provided to a controller for controlling the outdoor unit.

In the above refrigeration system, the controller of the outdoor unit may be connected to respective controllers of the plural chiller units through a communication line, and when any one of the first unit and the second unit is selected by the selecting unit, the controller of the outdoor controller may cooperate with the controllers of the chiller units to make the selected means execute.

According to a third aspect of the present invention, there is provided an air conditioner having an outdoor unit, a chiller unit having a heat exchanger which is supplied with refrigerant from the outdoor unit through a refrigerant pipe and also supplied with water medium through a water medium pipe, and a direct-expansion indoor unit supplied with the refrigerant from the outdoor unit through the refrigerant pipe, the chiller unit and the direct-expansion indoor unit being connected to the outdoor unit through the refrigerant pipe in parallel, wherein the direct-expansion indoor unit has a first thermo-off unit for executing thermo-off on the direct-expansion indoor unit when the temperature of refrigerant flowing through the direct-expansion indoor unit reaches an icing temperature of drain, and the chiller unit has a second thermo-off unit for executing thermo-off on the chiller unit when any one of the temperature of the water medium flowing through the chiller unit, the temperature of the refrigerant flowing through the chiller unit and the temperature of the heat exchanger reaches a freeze-assumed temperature of water.

In the above air conditioner, the first thermo-off unit may execute thermo-off on the direct-expansion indoor unit when the state that the temperature of the refrigerant is less than the icing temperature or less is continued for a predetermined time.

In the above air conditioner, the first thermo-off unit may have an indoor refrigerant temperature sensor for detecting the temperature of the refrigerant.

In the above air conditioner, the second thermo-off unit may have a chiller refrigerant temperature sensor for detecting the temperature of the refrigerant, a chiller water medium temperature sensor for detecting the temperature of the water medium, a heat exchanger temperature sensor for detecting the surface temperature of the heat exchanger, and an outside air temperature sensor for detecting the outside air temperature.

In the above air conditioner, the air conditioner further have a circulating pump for supplying water medium to the chiller unit, and a unit for instructing to start the operation of the circulating pump when the outside air temperature reaches a freeze-assumed temperature.

According to the present invention, the paddle type flow switch is provided in the chiller unit, and thus the labor imposed on the work associated with the installation of the chiller unit can be reduced. Furthermore, the flow switch is provided at the lower stage portion in which the space can be secured, and thus the maintenance performance of the flow switch can be enhanced the flow switch is provided at the place in the water medium pipe where the effect of the vibration is little, so that the malfunction caused by the vibration can be prevented, and thus the flow of water medium can be substantially accurately detected.

Furthermore, according to the present invention, by using the third function provided to the controller of the outdoor unit, the worker can easily switch the first function and the second function to each other in accordance with the situation that the refrigeration system is equipped with a single-system water medium pipe or multi-system water medium pipes. Therefore, the installation work of the refrigeration system can be simply performed.

Still furthermore, according to the present invention, in the air conditioner in which the indoor unit and the chiller unit are connected to the outdoor unit in parallel, the icing (freezing) of drain in the heat exchanger of the direct-expansion indoor unit can be prevented, and the smooth air-conditioning operation can be performed. In addition, the freezing of cold water of the chiller unit can be prevented.

### BRIEF DESCRIPTION OF THE DRAWINGS

FIG. 1 is a refrigerant circuit diagram showing a refrigerating machine having a chiller unit according to a first embodiment;

FIG. 2 is a front view of the chiller unit and an outdoor unit when the chiller unit and the outdoor unit are arranged side by side;

FIG. 3 is a back view showing the chiller unit and the outdoor unit when the chiller unit and outdoor unit are arranged side by side;

FIG. 4 is a top view showing the chiller unit and the outdoor unit when the chiller unit and the outdoor unit are arranged side by side;

FIG. 5 is a perspective view showing the chiller unit when the chiller unit is viewed from a side at which an electrical component box is disposed;

FIG. 6 is a perspective view showing the chiller unit when the chiller unit is viewed from a side at which the electrical component box is not disposed;

FIG. 7 shows a flow-out side water medium pipe in the vicinity of a flow switch when the flow-out side water medium pipe is viewed from the upper side;

FIG. 8 is a cross-sectional view of VIII-VIII in FIG. 7;

FIG. 9 is a front view showing the flow switch which is secured to the flow-out side water medium pipe;

FIG. 10 is a refrigerant circuit diagram of a refrigerating machine having a chiller unit according to a second embodiment;

FIG. 11 is a perspective view showing the chiller unit when the chiller unit is viewed from a side at which an electrical component box is disposed;

FIG. 12 is a perspective view showing the chiller unit when the chiller unit is viewed from a side at which the electrical component box is not disposed;

FIG. 13 is a diagram showing a refrigeration system having a water medium pipe of plural systems according to a third embodiment;

FIG. 14 is a flowchart showing the operation of the refrigeration system;

FIG. 15 is a diagram showing the construction of the refrigeration system having a single system of water medium pipe;

FIG. 16 is a diagram showing another construction of the refrigeration system having a single system of water medium pipe;

FIG. 17 is a flowchart showing the operation of the refrigeration system;

FIG. 18 is a schematic diagram showing the construction of an air conditioner according to a fourth embodiment; and

FIG. 19 is a flowchart showing the operation of the chiller unit according to the fourth embodiment when cold water is generated.

### DETAILED DESCRIPTION OF THE PREFERRED EMBODIMENTS

Preferred embodiments according to the preset invention will be described.

### First Embodiment

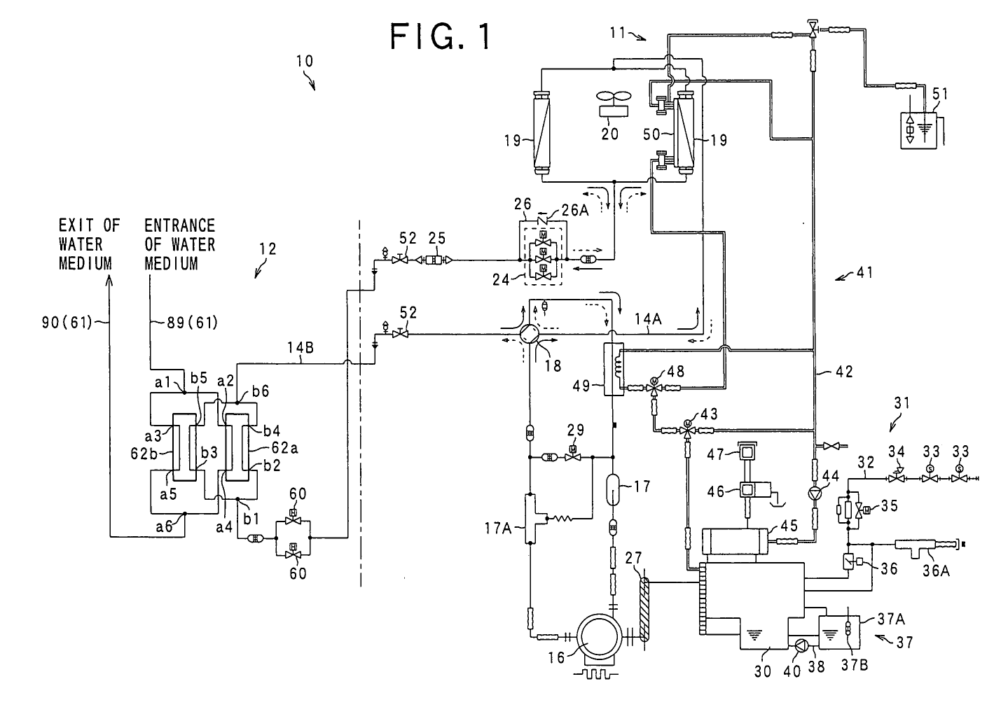

FIG. 1 is a refrigerant circuit diagram showing a refrigeration unit 10 having a chiller unit 12 according to a first embodiment.

As shown in FIG. 1, the refrigeration unit 10 has an outdoor unit 11 and a chiller unit 12, and an outdoor refrigerant pipe 14A of the outdoor unit 11 and a chiller-side refrigerant pipe 14B of the chiller unit 12 are joined to each other through closing valves 52, 53, thereby forming a refrigeration cycle 10A. In the following description, the outdoor refrigerant pipe 14A and the chiller-side refrigerant pipe 14B are generically referred to as “refrigerant pipe 14” unless there are specifically distinguished from each other.

A compressor 16 is disposed in the outdoor refrigerant pipe 14A of the outdoor unit 11. The compressor 16 is driven through a V belt 27 by a gas engine 30. An accumulator 17 is disposed at the suction side of the compressor 16, and a four-way valve 18 is disposed through an oil separator 17A at the discharge side of the compressor 16. An outdoor heat exchanger 19, an outdoor expansion valve 24 and a dry core 25 are successively connected to the four-way valve 18 in this order. Furthermore, a refrigerant-system bypass pipe 26 so as to bypass the outdoor expansion valve 24, and the refrigerant-system bypass pipe 26 is provided with a check valve 26A for preventing back flow of refrigerant. An outdoor fan 20 is disposed adjacently to the outdoor heat exchanger 19 so as to blow air to the outdoor heat exchanger 19. Reference numeral 29 represents a relief valve for releasing the pressure of the refrigerant at the discharge side of the compressor 16 to the suction side of the compressor 16.

The gas engine 30 for driving the compressor 16 is supplied with air-fuel mixture from an engine fuel supply device 31. In the engine fuel supply device 31, two fuel cutoff valves 33, a zero governor 34, a fuel adjusting valve 35 and an actuator 36 are successively disposed in a fuel supply pipe 32, and the side end portion of the actuator 36 of the fuel supply pipe 32 is connected to the gas engine 30. An air cleaner 36A is connected to the fuel supply pipe 32.

An engine oil supply device 37 is connected to the gas engine 30. In the engine oil supply device 37, an oil supply pump 40 is disposed in the oil supply pipe 38, and engine oil is timely supplied to the gas engine 30. The engine oil supply device 37 is provided with a sub oil pan 37A and an oil level switch 37B.

Furthermore, the outdoor unit 11 is provided with an engine cooling device 41 for withdrawing heat of the gas engine 30 by circulating cooling water through the gas engine 30, and the engine cooling device 41 is provided with an electrically-operated cooler three-way valve 43 which is connected through a pipe to a cooling water medium pipe through which cooling water flows.

A circulating pump 44 and an exhaust gas heat exchanger 45 are successively connected to one of the outlets of the electrically-operated cooler three-way valve 43, and a passage through which cooling water passing through the gas engine 30 is returned to the gas engine 30 is formed by a pipe route for connecting the electrically-operated cooler three-way valve 43, the circulating pump 44 and the exhaust gas heat exchanger 45. Here, the exhaust gas heat exchanger 45 is a heat exchanger for performing the heat exchange between the exhaust gas from the gas engine 30 and the cooling water, and an exhaust muffler 46 and an exhaust top 47 for processing exhaust gas are connected to the exhaust gas heat exchanger 45.

The inlet of a cooling water electrically-operated three-way valve 48 is connected to the other outlet of the electrically-operated cooler three-way valve 43. One end of a exhaust heat withdrawing heat exchanger 49 is connected to one outlet of the cooling water electrically-operated three-way valve 48 through a pipe, and one end of a radiator 50 is connected to the other end of the cooling water electrically-operated three-way valve 48 through a pipe. Here, the exhaust heat withdrawing heat exchanger 49 is a heat exchanger for performing the heat exchange between the refrigerant in the outdoor refrigerant pipe 14A and the cooling water in the cooling water medium pipe 42. In this embodiment, a plate type heat exchanger is applied as the heat exchanger concerned. The radiator 50 cools the cooling water passing through the radiator 50, and it is disposed adjacently to the outdoor fan 20 so that air is blown from the outdoor fan 20 to the radiator 50. Reference numeral 51 represents a cooling water reserve tank for pooling cooling water to be timely supplied to the cooling water medium pipe 42.

The chiller unit 12 performs the heat exchange between water medium passing through the water medium pipe 61 and flowing into the chiller unit 12 and refrigerant of the chiller-side refrigerant pipe 14B connected to the outdoor refrigerant pipe 14A to generate cold water or hot water. The chiller unit 12 is equipped with plate type heat exchangers 62a, 62b for performing the heat exchange between the refrigerant and the water medium.

The water medium pipe 61 has a flow-in side water medium pipe 89 through which water medium to flow into the plate type heat exchangers 62a, 62b flows, and a flow-out side water medium pipe 90 through which water medium to flow out from the plate type heat exchangers 62a, 62b flows. The flow-in side water medium pipe 89 is branched at a branch point a, and one of the branched pipes is connected to the plate type heat exchanger 62a at a connection portion a2 while the other pipe is connected to the plate type heat exchanger 62b at a connection portion a3. Furthermore, the flow-out side water medium pipe 90 connected to the connection portion a4 of the plate type heat exchanger 62a and the flow-out side water medium pipe 90 connected to the connection portion a5 of the plate type heat exchanger 62b join together at a confluent point a6, and lead out.

Two electrically-operated valves 60 for controlling the flow rate (amount) of the refrigerant flowing through the chiller-side refrigerant pipe 14B are connected to the chiller-side refrigerant pipe 14B. The chiller-side refrigerant pipe 14B connected to the electrically-operated valve 60 is branched at a branch point b1, and then one of the branched pipes is connected to the plate type heat exchanger 62a at a connection portion b2 while the other pipe is connected to the plate type heat exchanger 62b at a connection portion b3. Furthermore, the chiller-side refrigerant pipe 14B connected to the connection portion b4 of the plate type heat exchanger 62a and the chiller-side refrigerant pipe 14B connected to the connection portion b5 of the plate type heat exchanger 62b are connected to each other at a branch point b6.

As described above, in the chiller unit 12 of this embodiment, the two plate type heat exchangers 62a, 62b are provided in parallel to the water medium pipe 61, and also the two plate type heat exchangers 62a, 62b are provided in parallel to the chiller-side refrigerant pipe 14B. Therefore, the temperature of the refrigerant flowing in the plate type heat exchanger 62a and the temperature of the refrigerant flowing into the plate type heat exchanger 62b can be set to be substantially equal to each other, and also the water media flowing in the two plate type heat exchangers 62a and 62b in parallel can be cooled or heated substantially at the same temperature, whereby cold water or hot water can be generated at a desired temperature with high precision.

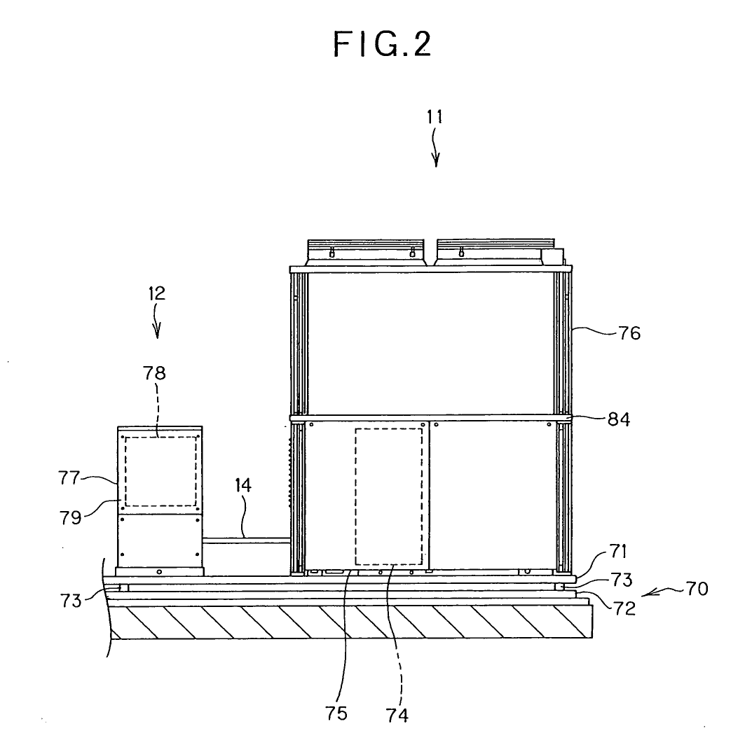

FIGS. 2 to 4 show a state that the outdoor unit 11 and the chiller unit 12 are disposed outdoors, and are front view, back view and top views of the outdoor unit 11 and the chiller unit 12.

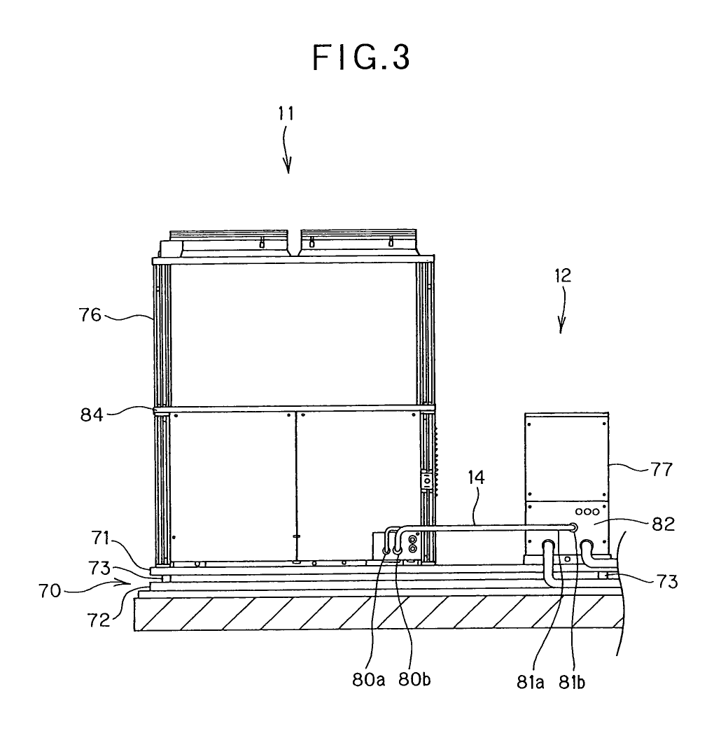

In this embodiment, as shown in FIGS. 2 to 4, the outdoor unit 11 and the chiller unit 12 are disposed and fixed on a dedicated vibration-proof table while arranged side by side. As shown in FIGS. 2 and 3, the vibration-proof table 70 has a first plate 71 on which the outdoor unit 11 and the chiller unit 12 are mounted and fixed, and a second plate 72 disposed at the lower side of the first plate 71. A cushioning member 73 is interposed between the first plate 71 and the second plate 72, and vibration occurring when the outdoor unit 11 is operated is absorbed by the cushioning member 73. This construction prevents the outdoor unit 11 and the chiller unit 12 from being adversely affected by the vibration occurring under the operation of the outdoor unit 11.

Furthermore, the outdoor unit 11 and the chiller unit 12 are mounted side by side on the dedicated vibration-proof table 70. Therefore, a worker or the like can easily perform the installation work by securing the outdoor unit 11 and the chiller unit 12 at predetermined positions of the vibration-proof table 70, and thus the working efficiency can be enhanced.

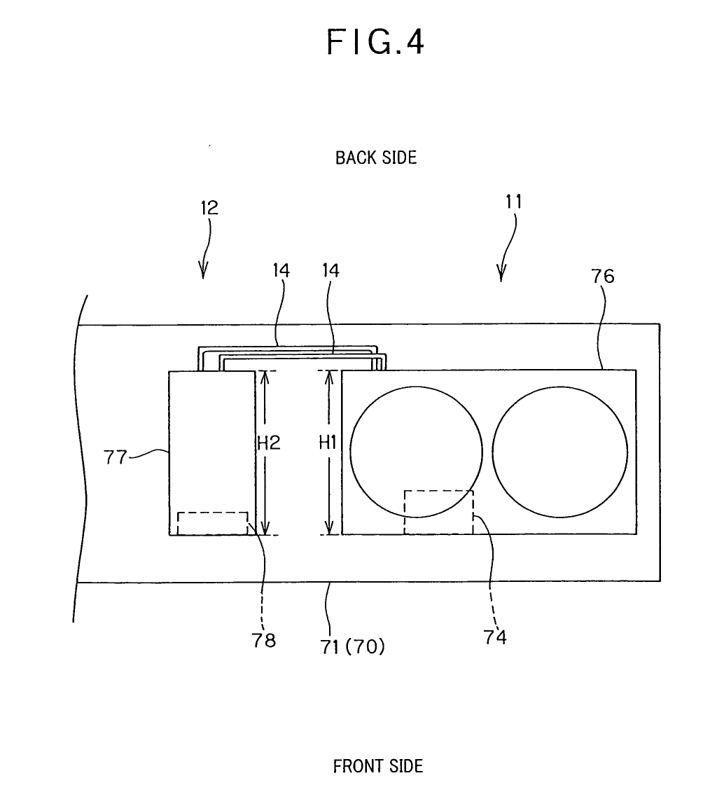

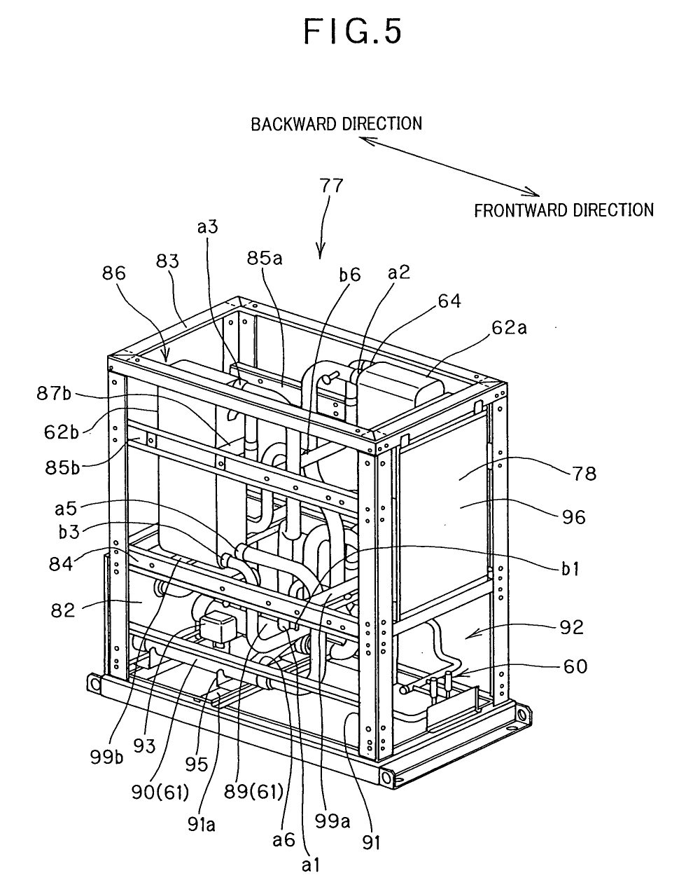

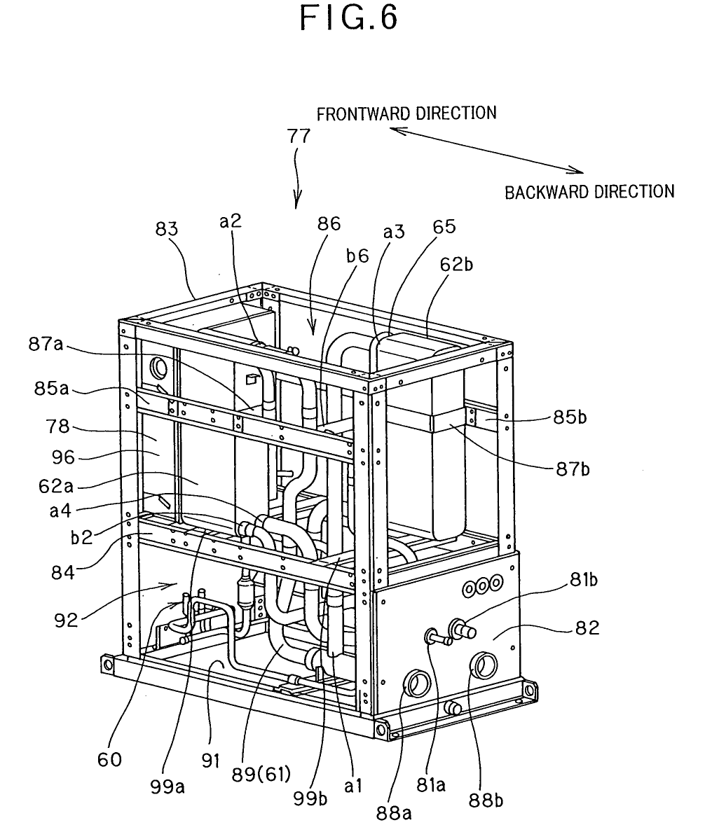

Furthermore, as shown in FIGS. 2 and 4, an electrical component box 74 containing electrical equipment for controlling each equipment of the outdoor unit is provided at the front surface side of the outdoor unit main body 74 of the outdoor unit 11, and the worker or the like can easily access the electrical component box 74 by detaching a front panel 75 provided at the front side of the electrical component box 74. Likewise, an electrical component box 78 containing electrical equipment for controlling each equipment of the chiller unit 12 is provided at the front surface side of the chiller unit main body 77 (FIGS. 5 and 6), and the worker or the like can easily access the electrical component box 78 by detaching a front panel (FIG. 2) provided in front of the electrical component box 78.

The control electrical devices mounted in the electrical component box 74 and the control electrical devices mounted in the electrical component box 78 are connected to one another through wires (not shown) so that signal communication can be performed. These control electrical devices operate in cooperation and control the respective devices of the outdoor unit 11 and the chiller unit 12.

Here, the electrical component boxes 74, 78 have the electrical devices, and thus maintenance occurs relatively frequently, so that these electrical component boxes 74 and 78 are required to be easily accessible. Furthermore, the control electrical devices of the electrical component boxes 74, 78 operate in cooperation with each other, and the electrical component boxes 74 and 78 are required to be simultaneously subjected to maintenance. In this embodiment, the outdoor unit 11 and the chiller unit 12 are arranged side by side on the vibration-proof table 70, and also the electrical component box 74 is disposed at the front surface side of the outdoor unit main body 76 while the electrical component box 78 is disposed at the front surface side of the chiller unit 12. The worker or the like can easily access the electrical component boxes 74 and 78 by detaching the front panel 75 of the outdoor unit 1 and the front panel 79 of the chiller unit 12, and also the maintenance can be simultaneously executed on the electrical component boxes 74 and 78.

According to this embodiment, when the maintenance is simultaneously executed on the electrical component box 78 of the chiller unit 12 and the electrical component box 74 of the outdoor unit 11, the worker or the like can access these electrical component boxes 74 and 78 from the same side, and thus the maintenance performance can be enhanced.

Furthermore, as shown in FIG. 3, refrigerant-pipe through holes 80a, 80b through which the refrigerant pipes penetrate are formed in the back surface of the outdoor unit main body 76, and also refrigerant-pipe through holes 81a and 81b through which the refrigerant pipes penetrate are formed in the back panel 82 of the chiller unit main body 77. The refrigerant pipe 14 led out from the outdoor unit main body 76 through the refrigerant-pipe through holes 80a, 80b extends to the neighborhoods of the refrigerant-pipe through holes 81a and 81b, and led into the chiller unit main body 77 through the refrigerant-pipe through holes 81a and 81b, whereby the outdoor refrigerant pipe 14A (FIG. 1) and the chiller-side refrigerant pipe 14B (FIG. 1) are connected to each other. As described above, according to this embodiment, the refrigerant pipe 14 exposed to the outside is located at the back sides of the outdoor unit main body 76 and the chiller unit main body 77. Therefore, when the outdoor unit 11 and the chiller unit 12 mounted on the vibration-proof table 70 are viewed from the front side, the refrigerant pipe 14 is hardly viewed, and thus the exterior appearance is enhanced.

Still furthermore, according to this embodiment, as shown in FIG. 4, the width H1 in the depth direction of the outdoor unit 11 and the width H2 in the depth direction of the chiller unit 12 are set to be substantially equal to each other, whereby the sense of unity between the outdoor unit 11 and the chiller unit 12 is enhanced and the exterior appearance is enhanced. In addition, the refrigerant pipe 14 between the refrigerant-pipe through holes 80a, 80b and the refrigerant-pipe through holes 81a, 81b can be formed to be substantially linear, so that the processing of the refrigerant pipes 14 can be facilitated and the cost can be reduced.

FIG. 5 is a perspective view showing the chiller unit main body 77 when viewed from a side at which the electrical component box 78 is disposed, and FIG. 6 is a perspective view showing the chiller unit main body 77 when viewed from a side at which the electrical component box 78 is not disposed. In FIGS. 5 and 6, the side panels constituting the side surface of the chiller unit main body 77 and the top panel constituting the upper surface of the chiller unit main body 77 are detached from the chiller unit main body 77. Aback panel 82 as a part of the panel provided to the back surface of the chiller unit main body 77 are secured to the chiller unit main body 77 for convenience of description.

As shown in FIGS. 5 and 6, the chiller unit main body 77 is formed substantially in a rectangular parallelepiped shape, and has a frame 83 constituting the respective side portions of the chiller unit main body 77. The frame 83 has a center lateral frame 84 which is provided at the substantially center position in the height direction of the chiller unit main body 77 so as to extend in the horizontal direction, and two partition plates 99a, 99b (support table) extending in the horizontal direction are fixed to the center lateral frame 84. The inside of the chiller unit main body 77 is partitioned into upper and lower stages by the partition plates 99a, 99b. Upper lateral frames 85a, 85b are respectively provided above the center lateral frame 84 at the side portions of the chiller unit main body 77 so as to be bridged between vertically-extending frames.

The electrical component box 78 described above and plate type heat exchangers 62a and 62b are provided in the upper chamber (upper stage portion) formed at the upper stage of the chiller unit main body 77 which is partitioned by the partition plates 99a, 99b. The plate type heat exchangers 62a, 62b are fixed through support plates 87a, 87b (in FIG. 5, the support plate 87a is not illustrated) to the upper lateral frames 85a, 85b provided to the sides of the chiller unit main body 77 while mounted and supported on the partition plate 99a and 99b, and are firmly secured so that no displacement occurs in the horizontal and vertical directions.

Here, when the plate type heat exchangers 62a and 62b which are heavier in weight than the other equipment are provided in the upper stage chamber 86, there is a risk that the center of gravity of the chiller unit main body 77 is shifted to a higher position as compared with the case where the plate type heat exchangers 62a and 62b are provided in the low stage chamber 92 (lower stage portion), so that the safety of the chiller unit main body 77 itself may be lost. In view of the foregoing risk, according to this embodiment, the plate type heat exchangers 62a and 62b are arranged in the upper stage chamber 86 in consideration of the total weight balance of the chiller unit main body 77. That is, the plate type heat exchanger 62a is fixed at the front side of the upper lateral frame 85a disposed at one side portion of the chiller unit main body 77, and the plate type heat exchanger 62b is fixed at the back side of the upper lateral frame 85b disposed at the other side of the chiller unit main body 77 so that the plate type heat exchangers 62a and 62b are spaced from each other to face each other diagonally (or located at the counter sides) in the upper stage chamber 86 so that the weight balance of the chiller unit main body 77 is kept). Accordingly, in the upper stage chamber 86, the plate type heat exchangers 62a and 62b are prevented from being arranged in an unbalanced style, so that the center of gravity of the chiller unit main body 77 can be prevented from being displaced and thus the safety of the chiller unit main body can be secured. Accordingly, when the chiller unit main body 77 is transported to an installation place or mounted on the vibration-proof table 70, the chiller unit 12 can be moved while stabilized, and thus the work can be facilitated.

The water medium pipe 61 and the chiller-side refrigerant pipe 14B are connected to the plate type heat exchangers 62a, 62b, and the construction of the water medium pipe 61 will be first described.

As shown in FIG. 6, the water-medium-pipe through holes 88a and 88b through which the water medium pipe 61 penetrates are formed at the lower portion of the back panel 82, and the water medium pipe 61 penetrates through the water-medium-pipe through holes 88a and 88b. When the water medium pipe 61 is made to penetrate through the water-medium-pipe through holes 88a and 88b, the water medium pipe 61 comes into contact with the edges of the water-medium-pipe through holes 88a and 88b, and thus it is kept to be supported by the edges of the water-medium-pipe through holes 88a and 88b. Here, the water medium pipe 61 is a pipe through which water medium flows, and it is larger in diameter and heavier in weight than the refrigerant pipe 14. However, by forming the water-medium-pipe through holes 88a and 88b at the lower portion of the back panel 82, the load imposed from the water medium pipe 61 to the back panel 82 can be reduced.

In this embodiment, the flow-in side water medium pipe 89 through which water medium to flow into the plate type heat exchangers 62a and 62b flows penetrates through the water-medium-pipe through hole 88a at the left side of FIG. 6 out of the two water-medium-pipe through holes 88a and 88b, and the flow-out side water medium pipe 90 through which water medium to flow out from the plate type heat exchangers 62a and 62b flows penetrates through the water-medium-pipe through hole 88b at the right side of FIG. 6.

As shown in FIG. 6, the flow-in side water-medium pipe 89 introduced in the chiller unit main body 77 through the water-medium-pipe through hole 88a extends horizontally along the lower surface 91 of the chiller unit main body 77 by a predetermined distance as shown in FIG. 6, and then is branched, at a branch point al, into a pipe through which water medium to flow into the plate type heat exchanger 62a and a pipe through which water medium to flow into the plate type heat exchanger 62b flows. The respective branched pipes are connected to the connection portions a2, a3 formed at the upper portion of the plate type heat exchangers 62a, 62b. In this case, as shown in FIGS. 5 and 6, the respective pipes are set not to extend to higher positions than the connection portions a2 and a3. That is, the flow-in side water medium pipes 89 corresponding to the connection pipes to be connected to the plate type heat exchangers 62a and 62b are not located at positions higher than the top portions of the plate type heat exchangers 62a and 62b.

In the chiller unit 12 in which the plate type heat exchangers 62a and 62b are provided in parallel to the water medium pipe 61 as in the case of the embodiment, it is required that the same flow amount of water medium flows into the respective plate type heat exchangers 62a and 62b. In order to satisfy this requirement, the distance from the branch point of the water medium pipe 61 to each of the plate type heat exchangers 62a, 62b is adjusted to be as long as possible so that the same flow amount of water medium flows into the plate type heat exchangers 62a and 62b. In this embodiment, as described above, the plate type heat exchangers 62a and 62b are provided in the upper stage chamber, and thus the distance between the branch point a1 of the lower stage chamber 92 and the connection portion a2, a3 of the plate type heat exchanger 62a, 62b can be set to a large value. Therefore, after the flow-in side water medium pipe 89 is branched in the lower stage chamber 92, and then the shape of the flow-in side water medium pipe 89 from the branch point till the connection point to the plate type heat exchanger 62a, 62b can be set to be substantially linear while the distance of the flow-in side water medium pipe 89 is set to be long. Accordingly, it is unnecessary to make the flow-in side water medium pipe 89 long in length by making the water medium pipe 61 meander in a Japanese shrine-gate shape, and thus places at which air is trapped can be excluded from the passage of the flow-in side water medium pipe 8, and the work of releasing air is unnecessary, so that the maintenance performance can be enhanced.

Particularly, in this embodiment, the flow-in side water medium pipe 89 serving as a flow dividing pipe is set so as not to extend to a position higher than the connection portions a2, a3 of the plate type heat exchangers 62a, 62b. Therefore, it is unnecessary that the flow-in side water medium pipe 89 is designed like the shape of a Japanese shrine-gate to connect the flow-in side water medium pipe 89 to the connection portions a2, a3, and thus air can be prevented from being trapped at the portion formed like the shape of the Japanese shrine-gate in the flow-in side water medium pipe 89.

Furthermore, in this embodiment, the plate type heat exchangers 62a, 62b are provided at the upper stage chamber 86, and thus the space can be secured in the lower stage chamber 92. The pipes for the flow division such as the flow-in side water medium pipe 89, etc. are collectively provided in the lower stage chamber 92, so that the space can be effectively used.

The flow-out side water medium pipes 90 through which water medium flowing out from the plate type heat exchangers 62a, 62b are led out (routed) from the connection portion a4 (FIG. 6) and the connection portion a5 (FIG. 5) which are formed at the lower side of the plate type heat exchangers 62a, 62b, and then join together at a predetermined position (joint point a6, FIG. 5) of the lower stage chamber 92 in which the space is secured. Furthermore, the jointed flow-out side water medium pipe 90 is formed to extend substantially horizontally along the lower surface 91 to the water-medium-pipe through hole 88b, passed through the water-medium-pipe through hole 88b and then led out to the outside of the chiller unit 77. Here, in this embodiment, the plate type heat exchangers 62a, 62b are disposed in the upper stage chamber 86, so that the large space can be secured in the lower stage chamber 92. Accordingly, the flow-out side water medium pipes 90 can be smoothly joined to each other by effectively using the space of the lower stage chamber 92 without extending the flow-out side water medium pipes 90 to a predetermined position to join together by making the flow-out side water medium pipes 90 meander.

As in the flow-in side water medium pipe 89, the flow-out side water medium pipes 90 serving as the connection pipes connected to the plate type heat exchangers 62a and 62b are set so as not to be located at positions higher than the plate type heat exchangers 62a and 62b. With this construction, as in the case of the flow-in side water medium pipe 89, it is unnecessary that the flow-out side water medium pipes 90 are designed like the shape of the Japanese shrine-gate to connect the flow-out side water medium pipes 89 to the connection portions a4, a5, and thus air can be prevented from being trapped at the portion formed like the shape of the Japanese shrine-gate in the flow-out side water medium pipes 90.

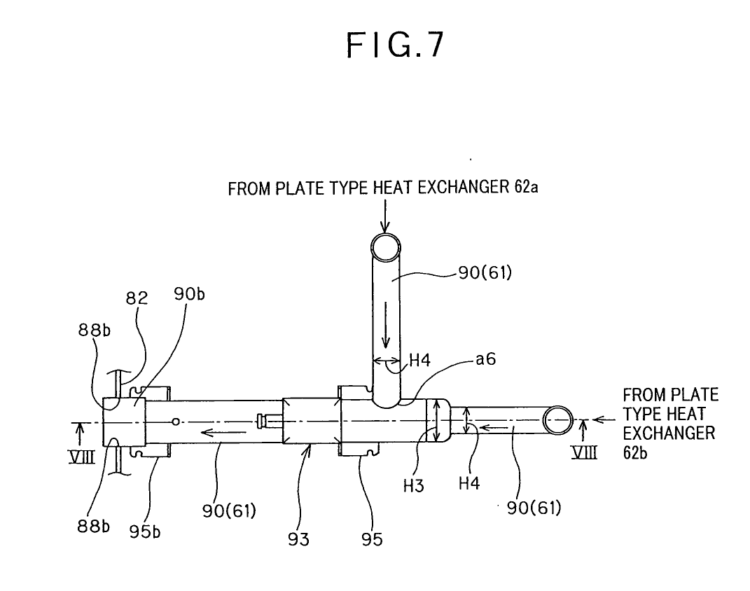

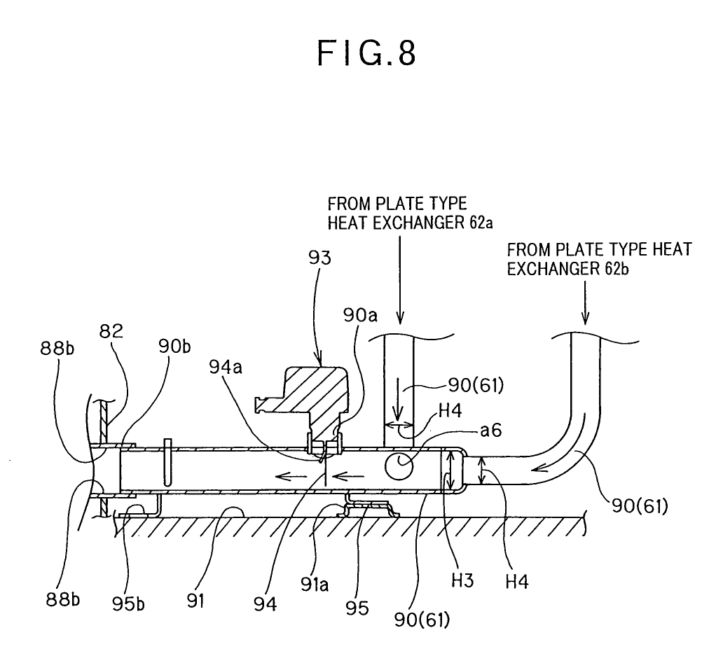

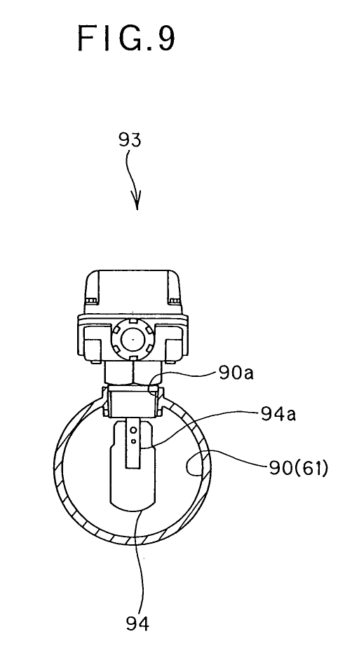

FIG. 7 is a top view showing the portion of the flow-out side water medium pipe 90 which extends substantially horizontally along the lower surface 91 to the water-medium-pipe through hole 88b, FIG. 8 is a cross-sectional view taken along a line of VIII-VIII of FIG. 7, and FIG. 9 is a front view showing the state that a flow switch 93 described later is secured to the flow-out side water medium pipe 90.

As shown in FIGS. 7 an 8, the diameter H3 of the flow-out side water medium pipe 90 at the surrounding portion of the joint point a6 is set to be larger than the diameter H4 of the flow-out side water medium pipe 90 at the portion which is located at the upstream side of the H3 portion with respect to the joint point a6. Accordingly, water media from the plate type heat exchangers 62a and 62b join together at the joint point a6, and volume-increased water medium can smoothly flow through the flow-out side water medium pipe 90. Furthermore, as shown in FIGS. 7 an 8, a penetration pipe 90b having a larger diameter than the diameter H3 penetrates through the water-medium-pipe through hole 88b while supported by the surrounding portion of the through hole 88b, and the tip of the flow-out side water medium pipe 90 is screwed into the penetration pipe 90b. With this construction, the worker or the like can easily lead the flow-out side water medium pipes 90 to the outside of the chiller unit main body 77 by executing the work of screwing the tip of the flow-out side water medium pipe 90 into the penetration pipe 90b.

As shown in FIGS. 5, 7 and 8, the portion of the flow-out side water medium pipe 90 which extends substantially horizontally along the lower surface 91 is provided with a paddle type flow switch 93. The flow switch 93 detects whether water medium flows through the flow-out side water medium pipe 90, thereby determining whether the water medium in the pipe freezes or not. As shown in FIGS. 8 and 9, the flow switch 93 is provided with a paddle 94 extending into the inside of the flow-out side water medium pipe 90. The water medium impinges against the paddle 94 while the water medium flows through the flow-out side water medium pipe 90, whereby the paddle 94 is displaced to the downstream side of the water medium, and a contact point (not shown) provided to the flow switch 93 is connected, whereby a signal indicating the flow of the water medium is transmitted to the control electrical equipment of the electrical component box 78.

The flow switch 93 is tightly screwed into and fixed to the screw port 90a provided at the upper portion of the flow-out side water medium pipe 90 with no clearance so as to prevent leakage of water medium from the fixing place of the flow switch 93. This paddle 94 is formed of a thin member having a substantially rectangular shape in front view (FIG. 9), and the paddle 94 extends vertically downwardly in the flow-out side water medium pipe 90, and surely impinges against the water medium flowing in the pipe. The shape of the paddle 94 of FIG. 9 is an example, and the shape and length of the paddle 94 may be properly changed in accordance with the application.

Here, when the flow switch 93 is actuated with high precision, it is desired that the paddle 94 is arranged vertically to the flow direction of the water medium. In this embodiment, as described above, the flow switch 93 is provided to the flow-out side water medium pipe 90 extending substantially horizontally, and thus the paddle 94 extending vertically downwardly in accordance with the gravitational force is perpendicular to the direction of the water medium flowing in the pipe, whereby the paddle type flow switch 93 can be actuated with high precision.

Furthermore, in this embodiment, the plate type heat exchangers 62a, 62b are provided in the upper stage chamber 86, thereby securing the space in the lower stage chamber 92, ad the flow switch 93 is provided in the lower stage chamber 92 in which the space concerned is secured. Therefore, maintenance can be done on the flow switch 93 by actively using the space, and thus the maintenance performance of the flow switch 93 is enhanced.

The freezing of the water medium which is excessively cooled by the plate type heat exchangers 62a and 62b successively starts from the water medium pipe 61 at the flow-out side of the water medium from the plate type heat exchangers 62a and 62b, that is, from the flow-out side water medium pipe 90. According to this embodiment, in view of this phenomenon, the flow switch 93 is provided to the water medium pipe 61, particularly to the flow-out side water medium pipe 90, and when freezing occurs in the water medium, the freezing can be rapidly detected by the flow switch 93.

When water medium in the water medium pipe 61 is frozen and thus does not flow in the water medium pipe 61 in the chiller unit 12, so that the flow switch 93 detects the freezing of the water medium in the pipe, the operation of the chiller unit 12 is temporarily stopped. Accordingly, the chiller unit 12 is prevented from being operated under the state that the water medium in the water medium pipe 61 is frozen, so that the water medium pipe 61, a pump (not shown) for making water medium flow through the water medium pipe 61, etc. can be prevented from being damaged.

As described above, the chiller unit 12 of this embodiment and the outdoor unit 11 are arranged side by side on the vibration-proof table 70, and vibration occurring in connection with the actuation of the outdoor unit 11 is slightly transmitted to the chiller unit 12. Here, the flow switch 93 detects on the basis of the displacement of the paddle 94 whether water medium flows or not. In order to enhance the detection precision, it is required that the transmission of the vibration to the paddle 94 is suppressed as much as possible. In view of this requirement, according to this embodiment, as shown in FIGS. 5, 7 and 8, a support frame 91a (FIGS. 5 and 8) is fixed to the lower surface 91, a fixing member 95 for fixing the flow-out side water medium pipe 90 and the support frame 91a is provided to the support frame 91a, and the flow switch 93 is provided to the flow-out side water medium pipe 90 in the neighborhood of the fixing member 95. Accordingly, the flow switch 93 is provided at the portion of the flow-out side water medium pipe 90 which is fixed by the fixing member 95 so that the vibration at this portion is suppressed at the maximum level. Accordingly, the transmission of the vibration to the flow switch 93 can be suppressed, and the detection precision of the flow switch 93 can be enhanced, so that the flow of the water medium can be substantially accurately detected.

Reference numeral 95b represents the fixing member for fixing the flow-out side water medium pipe 90 to the lower surface 91 in the neighborhood of the water-medium pipe through hole 88b.

Next, the construction of the chiller side refrigerant pipe 14B will be described.

As shown in FIG. 6, refrigerant pipe through holes 81a and 81b penetrating through the chiller-side refrigerant pipe 14B are formed in the back panel 82, and the refrigerant pipe 14 penetrates through the refrigerant pipe through holes 81a, 81b (see FIG. 3 as well as FIG. 60. When penetrating through the refrigerant pipe through holes 81a, 81b, the chiller-side refrigerant pipe 14B comes into contact with the edges of the refrigerant pipe through holes 81a, 81b, and is set to be supported by the edges of the refrigerant pipe through holes 81a, 81b.

As shown in FIG. 6, the chiller-side refrigerant pipe 14B which is made to penetrate through the refrigerant pipe through hole 81a and introduced into the chiller unit main body 77 extends substantially horizontally along the lower surface, and then is connected to an electrically-operated valve 60 provided at the front side of the lower stage chamber 92. The electrically-operated valve 60 is a valve for controlling the flow rate (amount) of refrigerant flowing in the chiller-side refrigerant pipe 14B. The electrically-operated valve 60 is connected to electronic equipment for control in the electrical component box 78 through a wire (not shown) so that signals can be communicated therebetween, and the opening/closing state of the electrically-operated valve is controlled by the electronic equipment for control.

As shown in FIGS. 5 and 6, the electrically-operated valve 60 is disposed below the electrical component box 78. The electrical component box 78 is wound by a heat insulating member 96 so that the effect of the temperature at the outside of the electrical component box 78 is prevented from being transmitted to the electrical equipment provided in the electrical component box 78. Therefore, the electrical equipment in the electrical component box 78 can be prevented from being adversely affected by the outside temperature, and also the temperature of the surface of the electrical component box 78 is also prevented from being extremely lower than the temperature of the surrounding of the electrical component box 78, so that dew condensation water is prevented from adhering to the surface of the electrical component box 78. In this embodiment, the electrically-operated valve 60 is disposed below the electrical component box 78 for which adhesion of dew condensation water is prevented. Accordingly, the electrical component box 78 serves as a roof, so that dew condensation water occurring in the chiller unit main body 77 can be prevented from dropping to the electrically-operated valve 60. Particularly, it is unnecessary to provide a special member such as a roof having a mechanism for preventing dew condensation water, an enclosure member for covering the electrically-operated valve 60 or the like in order to prevent dew condensation water from dropping to the electrically-operated valve 60, and the dropping of dew condensation water is prevented by using existing equipment, so that the cost can be reduced.

Furthermore, the physical distance between the electrically-operated valve 60 and the electrical component box 78 connected to the electrically-operated valve 60 through a wire is nearer, and thus the distance of the wire between the electrically-operated valve 60 and the electrical component box 78 can be shortened. Therefore, the cost can be reduced and also loose or slack of the wire can be prevented, so that the state of the wire can be prevented from being complex.

The chiller-side refrigerant pipe 14B led out from the electrically-operated valve 60 is branched at a branch point b1 (FIG. 5) in the lower stage chamber 92 in which the space is secured, and the branched pipes are connected to the connection portion b2 (FIG. 6) and the connection portion b3 (FIG. 5) which are formed at the lower portions of the plate type heat exchangers 62a and 62b respectively. In this embodiment, as described above, the plate type heat exchangers 62a and 62b are provided in the upper stage chamber 86, and thus the chiller-side refrigerant pipe 14B can be branched by using the space formed in the lower stage chamber 92 while the flow rate of the refrigerant flowing through the chiller-side refrigerant pipe 14B is kept adjustable. The chiller-side refrigerant pipes 14B which are connected to the connection portion b4 (FIG. 5) and the connection portion b5 (FIG. 6) of the plate type heat exchangers 62a and 62b respectively join together at the branch point b6 (FIG. 5), and then extend to the refrigerant pipe through hole 81b. As in the case of the water medium pipes 61, the chiller-side refrigerant pipes 14B are collectively disposed in the space formed in the lower stage chamber 92, and also arranged so as not to extend to positions higher than the top portions of the plate type heat exchangers 62a and 62b.

As described above, in this embodiment, the paddle type flow switch 93 is provided in the chiller unit main body 77, and the freeze of the water medium in the water medium pipe 61 is detected by using this flow switch 93. Here, when the flow switch 93 is actuated with high precision, it is desired that the paddle 94 is arranged vertically to the flow direction of the water medium. In this embodiment, as described above, the flow switch 93 is provided to the flow-out side water medium pipe 90 which is routed to extend substantially horizontally, and thus the paddle 94 extending vertically downwardly in accordance with the gravitational force is perpendicular to the direction of the water medium flowing in the pipe, whereby the paddle type flow switch 93 can be actuated with high precision.

Furthermore, in this embodiment, the plate type heat exchangers 62a, 62b are provided in the upper stage chamber 86, thereby securing the space in the lower stage chamber 92, ad the flow switch 93 is provided in the lower stage chamber 92 in which the space concerned is secured. Therefore, maintenance can be done on the flow switch 93 by actively using the space, and thus the maintenance performance of the flow switch 93 is enhanced.

In this embodiment, a fixing member 95 for fixing the flow-out side water medium pipe 90 to the lower surface 91 is provided at a portion which extends substantially horizontally along the lower surface 91 in the flow-out side water medium pipe 90, and the flow switch 93 is provided to the flow-out side water medium pipe 90 in the vicinity of the fixing member 95. Accordingly, the flow switch 93 is provided at a portion of the flow-out side water medium pipe 90 at which vibration is suppressed at maximum level because it is fixed by the fixing member 95, and vibration is suppressed from being transmitted to the flow switch 93, so that the detection precision of the flow switch 93 is suppressed from being transmitted. Therefore, the detection precision of the flow switch 93 can be enhanced, and the flow of the water medium can be substantially accurately detected.

Furthermore, in this embodiment, the plate type heat exchangers 62a, 62b are fixed to the upper lateral frames 85a and 85b through the support plates 87a and 87b (in FIG. 5, the support plate 87a is not shown) while mounted and supported on the partition plates 99a, 99b (support table). Therefore, the plate type heat exchangers 62a and 62b are firmly secured to the chiller unit main body 77 under the state that no wobbling occurs in the vertical and horizontal directions.

Still furthermore, in this embodiment, the plate type heat exchangers 62a and 62b are arranged in the upper stage chamber 86 in consideration of the overall weight balance of the chiller unit main body 77. That is, the plate type heat exchanger 62a is fixed to the front surface side of the upper lateral frame 85a disposed at one side portion of the chiller unit main body 77, and the plate type heat exchanger 62b is fixed to the back surface side of the upper lateral frame 85b disposed at the other side portion while facing the plate type heat exchanger 62a. Accordingly, In the upper stage chamber 86, the plate type heat exchangers 62a and 62b are prevented from being arranged with being displaced to some place, and thus the center of gravity of the chiller unit main body 77 is prevented from being displaced, so that stability of the chiller unit main body is secured. Accordingly, the chiller unit 12 can be moved under a stable and the work can be facilitated particularly when the chiller unit main body 77 is transported to a place where it is installed or when the chiller unit main body 77 is mounted on the vibration-proof table 70.

### Second Embodiment

In the above-described first embodiment, the chiller unit 12 has the two electrically-operated valves and the two plate type heat exchangers. However, the numbers of the electrically-operated valve and the plate type heat exchangers are not limited to those of the above embodiment, and these numbers may be set to three or more. In the following description, an embodiment of the chiller unit 12 having three electrically-operated valves and three plate type heat exchangers will be described.

In the description of this embodiment, the same constituent elements as the first embodiment are represented by the same reference numerals, and the description thereof is omitted.

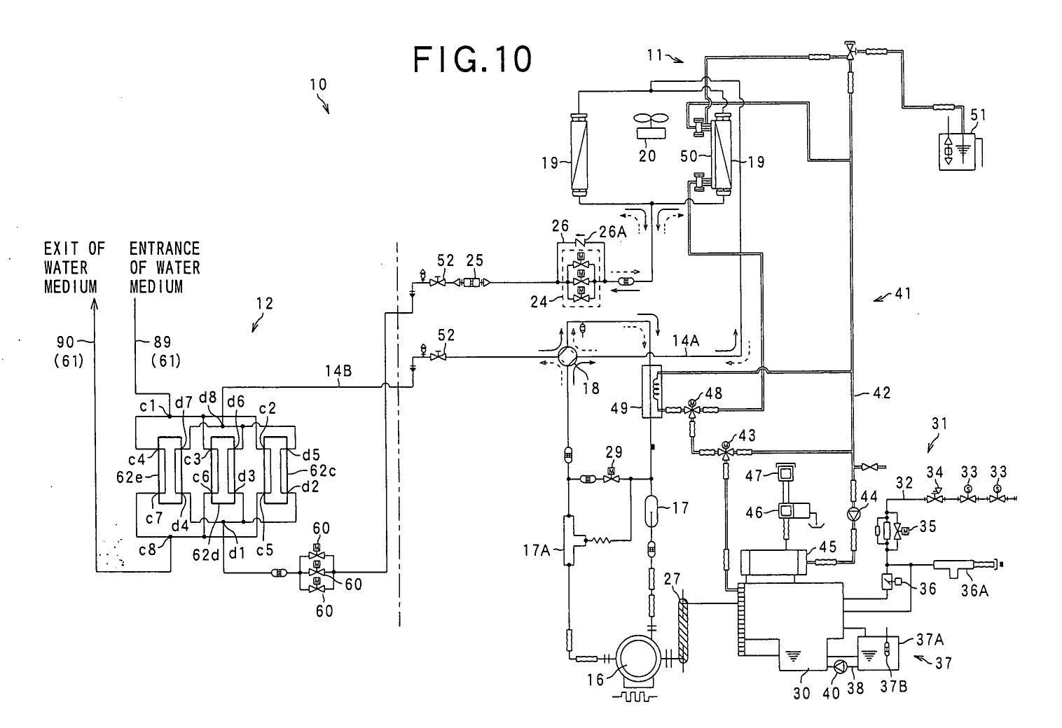

FIG. 10 is a refrigerant circuit diagram showing a refrigerating machine 10 having the chiller unit 12 according to this embodiment.

In the chiller unit 12 of this embodiment, three electrically-operated valves 60 are provided in parallel with respect to the chiller-side refrigerant pipe 14B as shown in FIG. 10. Furthermore, three plate type heat exchangers 62c, 62d, 62e are provided in parallel with respect to the chiller-side refrigerant pipe 14B and the water medium pipe 61, and a larger amount of cold water or hot water can be generated as compared with the first embodiment.

Specifically, after the flow-in side water medium pipe 89 is branched at the branch point c1, the respective branched pipes are connected to the connection portion c2 of the plate type heat exchanger 62c, the connection portion c3 of the plat type heat exchanger 62d and the connection portion c4 of the plate type heat exchanger 62e. Furthermore, the flow-out side branch pipes 90 connected to the connection portion c5 of the plate type heat exchanger 62c, the connection portion c6 of the plate type heat exchanger 62d and the connection portion c7 of the plate type heat exchanger 62e join together at the joint point c8, and then are led out to the outside of the chiller unit 12.

The chiller-side refrigerant pipe 14B connected to the electrically-operated valve 60 is branched at the branch point d1, and then the respective branched pipes are connected to the connection portion d2 of the plate type heat exchanger 62c and the connection portion d4 of the plate type heat exchanger 62d. Furthermore, the chiller-side refrigerant pipes 14B connected to the connection portion d5 of the plate type ht exchanger 62c, the connection portion d6 of the plate type heat exchanger 62d and the connection portion d7 of the plate type heat exchanger 62e join together at the branch point d8, and then are connected to the outdoor refrigerant pipe 14A.

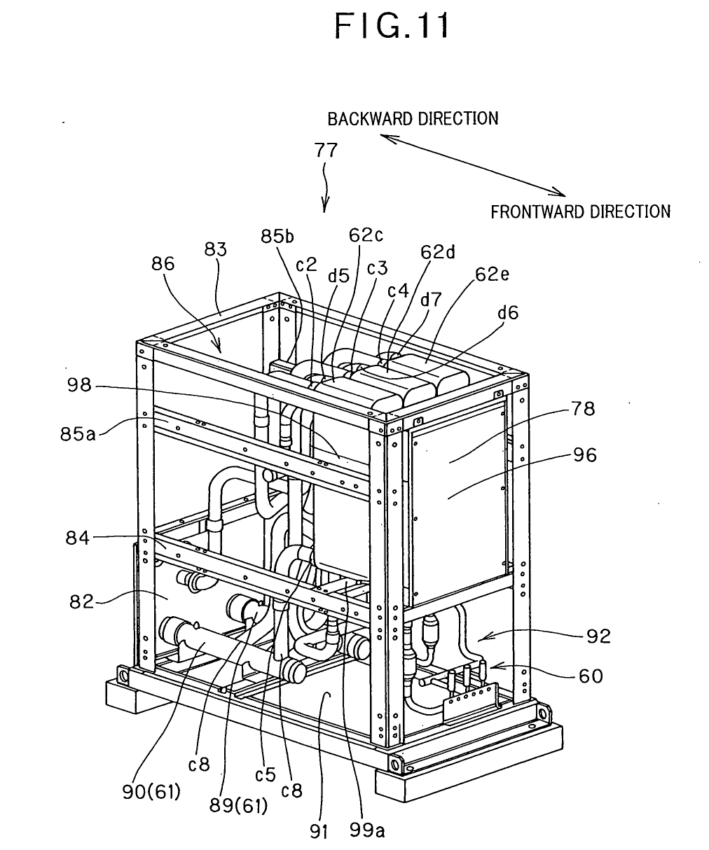

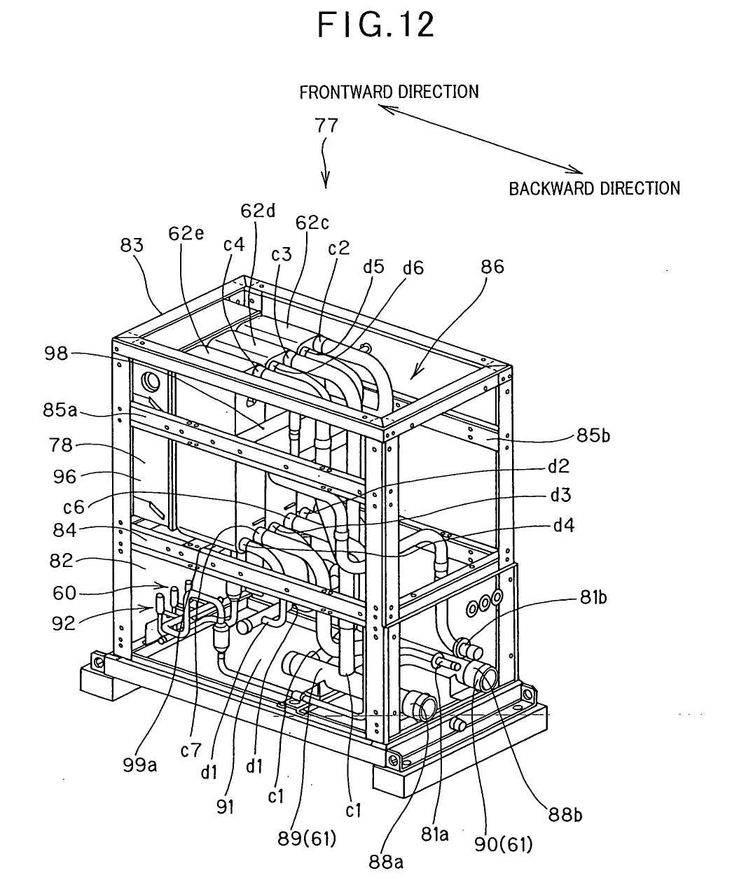

FIG. 11 is a perspective view showing the chiller unit main body 77 when the chiller unit main body 77 is viewed from a side at which the electrical component box 78 is disposed, and FIG. 12 is a perspective view showing the chiller unit main body 77 when the chiller unit main body 77 is disposed at a side at which the electrical component box 78 is disposed. The chiller unit 12 of this embodiment is juxtaposed with the outdoor unit 11 on the vibration-proof table 70 (see FIGS. 2 and 3), and the electrical component box 78 is provided at the front surface side. Therefore, as in the case of the first embodiment, the worker can simultaneously and easily access the electrical component box 74 of the outdoor unit 11 and the electrical component box 78 of the chiller unit 12.

As shown in FIGS. 11 and 12, in this embodiment, all the plate type heat exchangers 62a, 62b and 62c are disposed in the upper stage chamber 86. These plate type heat exchangers 62a, 62b and 62c are firmly fixed to the upper lateral frames 85a and 85b through the support plate 98 while mounted and fixed on the partition plate 99a. Furthermore, in this embodiment, the flow switch 93 may not be provided.

This embodiment achieves the same effect as the first embodiment. Specifically, the branch point of the flow-in side water medium pipe 89 is provided in the lower stage chamber 92, and the respective branched flow-in side water medium pipes 89 are arranged to extend substantially linearly and connect to the connection portions c2, c3, c4 of the upper portions of the plate type heat exchangers 62c, 62d and 62e while the distance from the branch point to each plate type heat exchanger is kept long. Therefore, any portion at which air is trapped in the passage of the water medium pipe 61 can be excluded while the apparatus can be adjusted so that the same amount of water medium flows into the plate type heat exchangers 62c, 62d and 62e. Accordingly, the air releasing work for releasing air is not required, and the maintenance performance can be enhanced. Furthermore, the three electrically-operated valves 60 are disposed below the electrical component box 78, and thus dew condensation water can be prevented from dropping to the electrically-operated valve 60 while the existing electrical component box 78 serves as a roof.

The present invention is not limited to the above embodiments, and various modification and applications may be made without departing from the subject matter of the present invention.

For example, in the above embodiments, the chiller unit 12 is equipped with two or three plate type heat exchangers. However, the number of the plate type heat exchangers is not limited to these values, and it may be properly changed in accordance with the amount (volume) of cold water or hot water to be generated.

Furthermore, in this embodiment, the inside of the chiller unit main body 77 is separated into the upper stage chamber 86 and the lower stage chamber 92 by the partition plate 99a. However, it is unnecessary that the inside of the chiller unit main body 77 is separated into the upper and lower stage chambers 86 and 92. That is, the plate type heat exchangers 62 may be provided at the upper portion of the chiller unit main body 77.

Still furthermore, in the above-described embodiment, the outdoor unit and the chiller unit (chiller unit main body) are provided one by one. However, the number of the outdoor unit and the chiller unit is not limited to one. A plurality of outdoor units and a plurality of chiller units may be provided. Furthermore, a plurality of (for example, three) chiller units may be connected to one outdoor unit.

### Third Embodiment

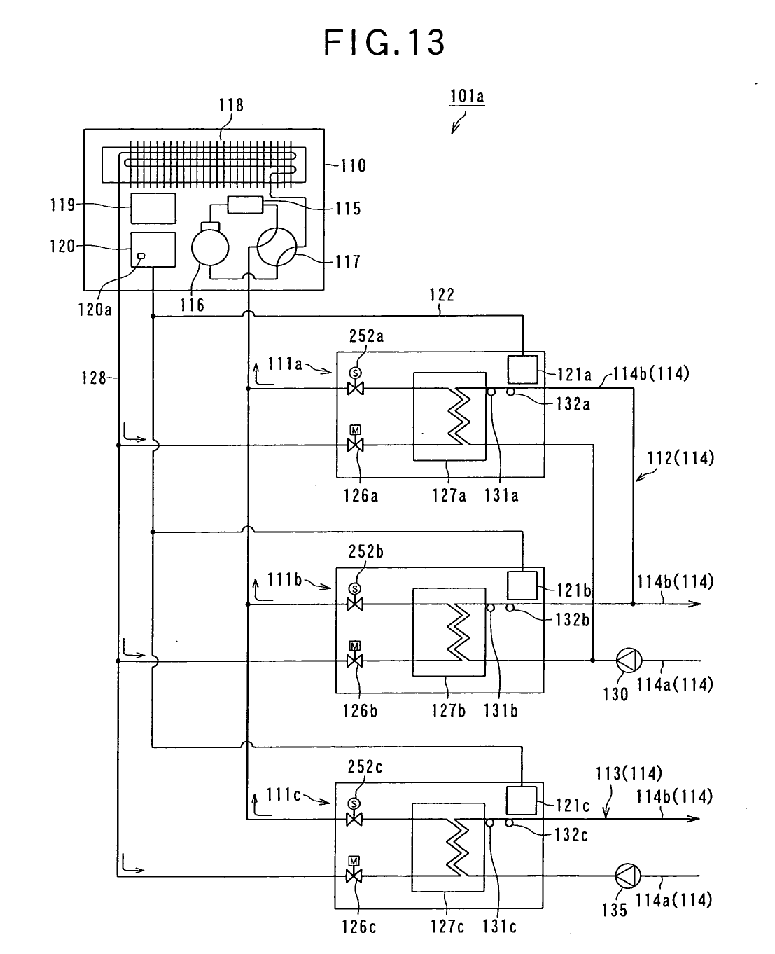

In the following embodiment, three chiller units are connected to one outdoor unit. FIG. 13 is a schematic diagram showing the construction of a refrigeration system 101a having a water medium pipe 114 of plural systems according to a third embodiment of the preset invention.

As shown in FIG. 13, the refrigeration system 101a has an outdoor unit 110, and three chiller units 111a, 111b, 111c are connected to the outdoor unit 110 in parallel through a single-system refrigerant pipe 128. The refrigeration system 101a also has the water medium pipe 114 of two systems, that is, a first-system water medium pipe 112 and a second-system water medium pipe 113. In FIG. 13, the chiller units 111a, 111b and 111c serve as refrigerant circuits which are set to generate cold water. The refrigeration system 101 under this state will be described hereunder.

As shown in FIG. 13, the outdoor unit 110 has an accumulator 115 for separating refrigerant into gas refrigerant and liquid refrigerant and leading out only the gas refrigerant, a compressor 116 for setting the refrigerant sucked from the accumulator 115 to a high-temperature and high-pressure state and leading out the refrigerant under high-temperature and high-pressure, a four-way valve 117 that is connected to the compressor 116 and changes the refrigerant circuit in accordance with the operation of generating cold/hot water, and an outdoor heat exchanger 118 for performing the heat-exchange between the refrigerant led out from the compressor 116 and air to liquefy the refrigerant, and then leading out the liquefied refrigerant. In addition, the outdoor unit 110 has a display unit 119 for displaying various kinds of information such as a present operation mode, a set temperature set as the temperature of cold water to be generated, etc.

The outdoor unit 110 has an outdoor controller 120 for controlling respective equipment equipped in the outdoor unit 110. The outdoor controller 120 is connected to chiller controllers 121a, 121b, 121c through a communication line 122 so that the outdoor controller d120 can perform communications with the chiller controllers 121a, 121b and 121c. These controllers cooperate with one another to perform the overall control of the refrigeration system 101a, for example, perform a level adjustment of the driving of the compressor 116, etc.

The chiller unit 111a has an opening/closing valve 252a for controlling introduction/interruption of refrigerant to/from the chiller unit 111a through the opening/closing operation of the opening/closing valve 252a, an expansion valve 126a for reducing the pressure of the refrigerant supplied from the outdoor heat exchanger 118 to obtain liquefied refrigerant under low-temperature and low-pressure, and a plate type heat exchanger 127a into which the refrigerant from the expansion valve 126a is introduced. The refrigerant pipe 128 and the water medium pipe 114 are connected to the plate type heat exchanger 127a, and heat-exchange is carried out between the refrigerant flowing through the refrigerant pipe 128 and the water medium flowing through the water medium pipe 114 to generate cold water (hot water in a hot water generating operation). The water medium pipe 114 has a flow-in side water medium pipe 114a through which water medium flows into the plate type heat exchanger 127a and a flow-out side water medium pipe 114b through which water medium flows out from the plate type heat exchanger 127a. At the outside of the chiller unit 111a, a first pump 130 for making water medium flow in the water medium pipe 114 is provided in the flow-in side water medium pipe 114a. The detail of the water medium pipe 114 will be described in detail later.

A water medium temperature sensor 131a for detecting the temperature of water medium is provided in the flow-out side water medium pipe 114b in the vicinity of the water-medium exit of the plate type heat exchanger 127a. Furthermore, a flow switch 132a for detecting whether water medium flows through the flow-out side water medium pipe 114b is provided to the flow-out side water medium pipe 114b in the vicinity of the water-medium exit of the plate type heat exchanger 127a.

The chiller unit 111a has a chiller controller 121a for controlling respective equipment equipped to the chiller unit 111a. The chiller controller 121a is connected to the first pump 130 described above so that communications can be performed therebetween, and start/stop of the operation of the first pump 130 is executed under the control of the chiller controller 121a or under the control of the outdoor controller 120 connected to the chiller controller 121a through a communication line 122.

Furthermore, the chiller controller 121a and the water medium temperature sensor 131a are connected to each other so that communications can be performed therebetween, and the chiller controller 121a detects the temperature of the water medium flowing out from the plate type heat exchanger 127a on the basis of the output value of the water medium temperature sensor 131a. Particularly, the chiller controller 121a compares the detected temperature of the water medium with an estimated temperature of freeze to detect whether the water medium may be frozen or not. In this embodiment, the water medium temperature sensor 131a is provided at the exit side of the plate type heat exchanger 127a. Here, the freeze of water medium which is excessively cooled by the plate type heat exchanger 127a successively starts from the water medium which flows out from the flow-out side of the plate type heat exchanger 127a. In this case, the water medium temperature sensor 131a is provided at the exit side of the plate type heat exchanger 127a, and thus the freeze of the water medium can be quickly detected.

Furthermore, the chiller controller 121a and the flow switch 132a are connected to each other so that the communications can be performed therebetween, and the chiller controller 121a detects on the basis of a signal input from the flow switch 132a whether water medium flows in the water medium pipe 114.

The chiller controller 121a according to this embodiment can detect occurrence of abnormality of the first pump 130 on the basis of the output value of the flow switch 132a. Specifically, when the operation of the first pump 130 is instructed and also the water medium is not frozen, the water medium flows through the water medium pipe 114 without being frozen, and thus the flow of the water medium could be detected by the flow switch 132a. In the above case, when it is detected by the flow switch 132a that the water medium does not flow, abnormality of the first pump 130 occurs due to a trouble or another cause, and the probability that the water medium does not normally flow is high. In consideration of this fact, the chiller controller 121a determines that abnormality of the first pump 130 occurs when the first pump 130 is instructed to operate, freeze of the water medium is not detected by the water medium temperature sensor 131a and also it is detected by the flow switch 132a that the water medium does not flow in the water medium pipe 114.

In the following description, “the flow switch 132a of the chiller unit 111a detects abnormality of the first pump 130” means the state that it is detected by the flow switch 132a that water medium does not flow although freeze of the water medium is not detected by the water medium temperature sensor 131a of the chiller unit 11a when the first pump 130 is instructed to operate.

The chiller unit 111b has substantially the same construction as the chiller unit 111a, and is equipped with a chiller controller 121b, an opening/closing valve 252b, an expansion valve 126b, a plate type heat exchanger 127b, a water medium temperature sensor 131b and a flow switch 132b.

The chiller unit 111c has substantially the same construction, and is equipped with a chiller controller 121c, an opening/closing valve 252c, an expansion valve 126c, a plate type heat exchanger 127c, a water medium temperature sensor 131c and a flow switch 132c.

Here, in the refrigeration system 101a according to this embodiment, the two systems of the first-system water medium pipe 112 and the second-system water medium pipe 113 exist as the water medium pipe 114 as shown in FIG. 13. The chiller unit 111a and the chiller unit 111b are connected to the first-system water medium pipe 112 in parallel, and the chiller unit 111c is connected to the second-system water medium pipe 113. The first pump 130 is provided in the first-system water medium pipe 112, and the second pump 135 is provided in the second-system water medium pipe 113.

As described above, in the refrigeration system 101a having the water medium pipes 114 of plural systems, when any one of the flow switches 132a, 132b and 132c of the chiller units 111a, 111b and 111c detects abnormality of the first pump 130 or the second pump 135, the operation of the outdoor unit 110 and the operation of all the first and second pumps 130 and 135 are required to be stopped. The reason for this is as follows.

That is, if the flow switch 132c of the chiller unit 111c connected to the second-system water medium pipe 13 detects abnormality of the second pump 135, the operation of the outdoor unit 110 and the operation of the second pump 135 must be stopped. The reason for this is as follows. That is, when abnormality of the second pump 135 is detected, there is a probability that water medium does not normally flow in the second-system water medium pipe 113 because of the abnormality of the second pump 135, and when the operation of the outdoor unit 110 and the operation of the second pump 135 are continued under the above state, the water medium in the plate type heat exchanger 127c may be excessively cooled to be frozen, or the second pump 135, the second-system water medium pipe 113, etc. may be damaged due to freeze of the water medium. Accordingly, when the flow switch 132c of the chiller unit 111c detects abnormality of the second pump 135, it is required to stop the operation of the outdoor unit 110 and the operation of the second pump 135 and prevent further damage of the second pump 135, etc. and it is also required to wait for a worker's investigation for the cause of the abnormality of the second pump 135.

On the other hand, even when any one of the flow switches 132a and 132b of the chiller units 111a and 111b connected to the first-system water medium pipe 112 detects abnormality of the first pup 130, safety can be secured without stopping the operation of the outdoor unit 110 and the operation of the first pump 130. The reason for this is as follows. In this case, one flow switch which does not detect abnormality of the first pump 130 guarantees that the first pump 130 operates normally, and thus it is estimated that water medium is normally circulated in the first-system water medium pipe 112, but the flow switch which detects the abnormality malfunctions. Accordingly, in the case where plural chiller units are connected to one water medium pipe in parallel as in the case of the chiller units 111a and 111b, it is unnecessary to stop the outdoor unit 110 and the pump even when the flow switch of any chiller unit detects abnormality, and it is necessary to stop the outdoor unit 110 and the pump when the flow switches of all the chiller units detect abnormality of the pump.

As described above, in the refrigeration system 101a, when the flow switch 132c detects abnormality of the second pump 135, it is necessary to stop the operation of the outdoor unit 110 and the operation of the first and second pumps 130, 135. However, when any one of the flow switches 132a and 132b detects abnormality of the first pump 130, it is unnecessary to stop the operation of the outdoor unit 110 and the operation of the first and second pumps 130 and 135. Here, the refrigeration system 101a has plural systems of water medium pipes 114, and thus the connection state of the water medium pipes 114 are more complicated as compared with the case that there is provided only one system (single-system) water medium pipe 114. Therefore, there is a case where a manager, a worker or the like of the refrigeration system 101a does not perfectly identify a flow switch which necessitates the stop of the outdoor unit and the pump when the flow switch concerned detects abnormality of the pump and are not required to be stopped when which flow switch detects abnormality of the pump, and a flow switch which does not necessitate the stop of the outdoor unit and the pump even when the flow switch concerned detects abnormality of the pump. In such a refrigeration system 101a, when any of the flow switches 132a, 132b, 132c detects abnormality of the first pump 130 or the second pump 135, for example, the processing of stopping or non-stopping the outdoor unit 110 in accordance with which one of the flow switches 132a, 132b, 132c detects abnormality of the pump is not executed, but all the operations of the outdoor unit 110 and the first and second pumps 130 and 135 are temporarily stopped to prevent occurrence of potential troubles which may happen subsequently. In this case, the worker or the like checks the connection state of the water medium pipes 114 or dissolve abnormality of the pump, and then operates the outdoor unit 110 and the necessary pump on the basis of the instruction of the worker or the like, thereby securing safety. This is also applicable to not only the refrigeration system 101a, but also a refrigeration system in which plural chiller units are connected to one outdoor unit in parallel and also plural systems of water medium pipes exist.

In view of the foregoing description, in this embodiment, a first function is applicable to a refrigeration system in which plural chiller units are connected to an outdoor unit through a refrigerant pipe and plural systems of water medium pipes are provided. The first function is a function (mode) for stopping the operation of the outdoor and the operation of the pump when at least any one of flow switches provided to the respective chiller units of the refrigeration system detects abnormality of the pump. Accordingly, when the first function is applied to the refrigeration system 101a according to this embodiment, when at least any one of the flow switches 132a, 132b, 132c of the chiller units 111a, 111b, 111c detects abnormality of first pump 130 or the second pump 135, the outdoor unit 110 and the first and second pumps 130 and 135 are stopped. Accordingly, the refrigeration system 101a can be operated with highest safety.

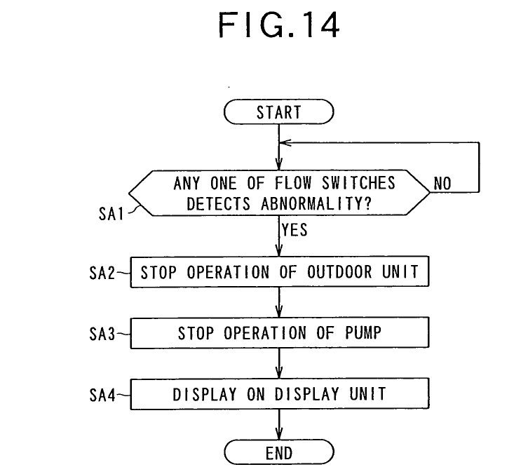

Next, the operation of the refrigeration system 101a to which the first function is applied will be described with reference to the flowchart of FIG. 14.

The outdoor controller 120 of the outdoor unit 110 transmits a control signal to the chiller controllers 121a, 121b, 121c which are connected to the outdoor controller 120 through a communication line that communications can be performed between each of the chiller controllers 121a, 12lb and 121c and the outdoor controller 120, and monitors whether at least any one of the flow switches 132a, 132b, 132c controlled by the chiller controllers 121a, 121b, 121c detects abnormality of the first pump 130 or the second pump 135 (step SA1). When at least one of the flow switches 122a, 132b, 132c detects abnormality of the first pump 130 or the second pump 135 (step SA1: YES), the outdoor controller 120 controls the operation of the compressor 116 to stop the operation of the outdoor unit 10 (step SA2), and further stops the operation of the first and second pumps 130, 135 (step SA3). Subsequently, the outdoor controller 120 displays on the display unit 119 which flow switch of the flow switches 132a, 132b, 132c detects the abnormality, and also displays on the display unit 119 the fact that the operation of the outdoor unit 110 and the operation of the first and second pumps 130, 135 are stopped (step SA4). Accordingly, the worker can easily and quickly recognizes that the operation of the outdoor unit 110 and the operation of the first and second pumps 130 and 135 are stopped, and also which pump of the first and second pumps 130 and 135 has abnormality. Therefore, the worker can efficiently perform repair and other works on the basis of this recognition.

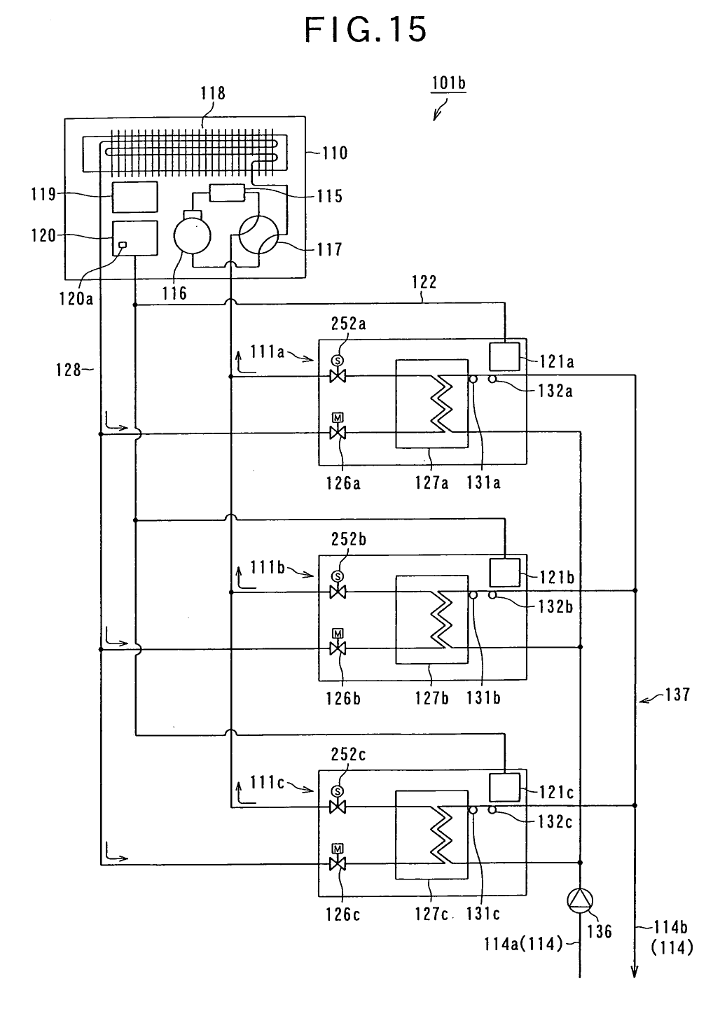

FIG. 15 shows a modification of the third embodiment shown in FIG. 13, and is a diagram showing the construction of a refrigeration system 101b having one-system (single-system) water medium pipe 14. In FIG. 15, the same constituent elements as shown in FIG. 13 are represented by the same reference numerals, and the description thereof is omitted.

As shown in FIG. 15, the refrigeration system 101b is different from the refrigeration system 101a in that it has only one-system water medium pipe 114 as a third-system water medium pipe 13, and the chiller units 111a, 111b, 111c are connected to the third-system water medium pipe 137 in parallel. A third pump 136 for making water medium flow in the pipe is provided in the third-system water medium pipe 137.

As described above, in the refrigeration system 101b having only single-system water medium pipe 114, when not all, but at least one of the flow switches 132a, 132b, 132c of the chiller units 111a, 111b, 111c connected to the third-system water medium pipe 137 detects abnormality of the third pump 136, the refrigeration system 101b can be operated with securing safety even when the outdoor unit 110 and the third pump 136 are not stopped. The reason for this is as follows. In this case, the flow switch which does not detect abnormality of the third pump 136 guarantees that the third pump 136 normally operates, and this state is estimated as a state that water medium is normally circulated in the third-system water medium pipe 137, but the abnormality-detecting flow switch itself malfunctions. Accordingly, in the case where the plural chiller units are connected to the single-system water medium pipe in parallel as described above, even when at least any one of the flow switches of the chiller units detects abnormality of the pump, the refrigeration system can be operated with securing safety without stopping the outdoor unit 110 and the pump, whereby the operability of the refrigeration system can be enhanced. On the other hand, when all the flow switches 132a, 132b, 132c of all the chiller units 111a, 111b, 111c detect abnormality of the third pump 136, abnormality actually occurs in the third pump 136 with high probability, so that the third pump 136 is required to be stopped.

The refrigeration system 101b is provided with the water medium pipe 114 of one system as the third-system water medium pipe 137. In this case, as compared with the refrigeration system 101a having the water medium pipes 114 of plural systems, the connection state of the water medium pipes 114 is simpler, and the worker or the like can more surely grasp the connection state of the water medium pipes 114. Accordingly, in the refrigeration system 101b, even when any one of the flow switches 132a, 132b, 132c detects abnormality of the third pump 136, it can be surely grasped that safety can be secured without stopping the respective operations of the outdoor unit 110 and the first pump 130. Therefore, in the refrigeration system 101b having the single-system (one-system) water medium pipe 114, it is unnecessary to stop the respective operations of the outdoor unit 110 and the third pump 136 even when at least any one of the flow switches 132a, 132b, 132c detects abnormality of the third pump 136.

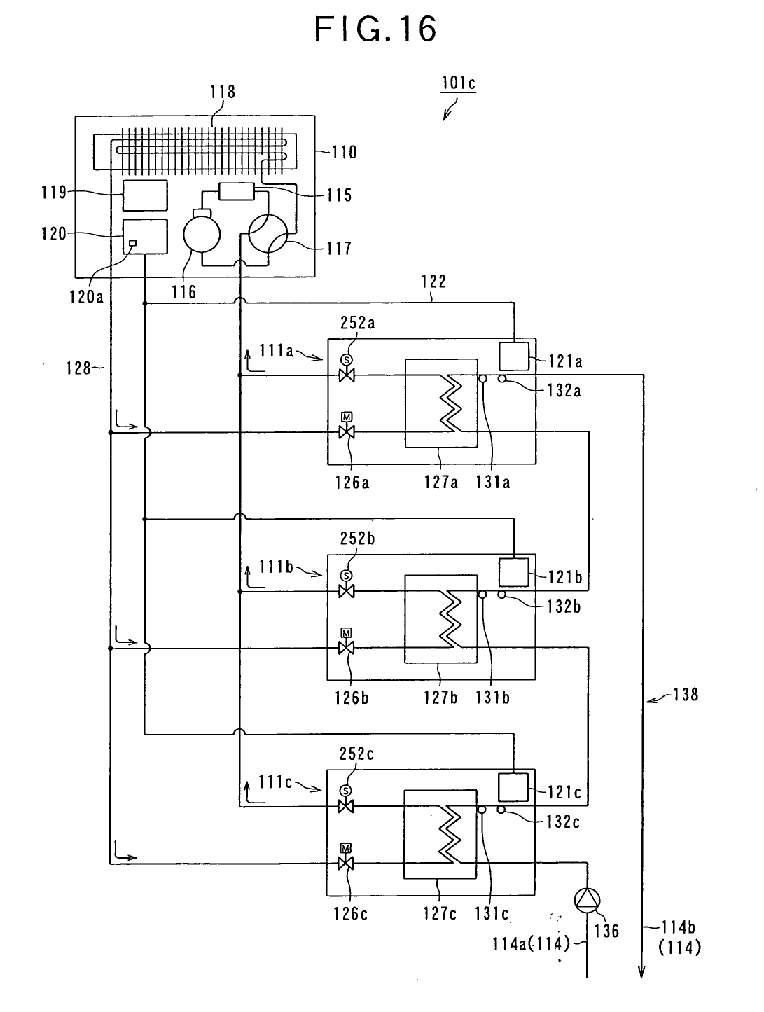

Here, a refrigeration system 101c as another example of the refrigeration system in which plural chiller units are connected to the outdoor unit 110 through the refrigerant pipe 128 in parallel and the single-system water medium pipe exists will be described with reference to FIG. 6. In FIG. 16, the same constituent elements as shown in FIGS. 13 and 15 are represented by the same reference numerals, and the description thereof is omitted.

As shown in FIG. 16, the refrigeration system 101c has only the single-system water medium pipe 114 as a fourth-system water medium pipe 138, and the chiller units 111a, 111b, 111c are connected to the fourth-system water medium pipe 138 in series. That is, the refrigeration system 101c is different from the refrigeration system 101b having the chiller units 111a, 111b, 111c connected to the water medium pipe 114 in parallel in that the chiller units 111a, 111b, 111c are connected to the water medium pipe 114 in series. For the same reason described with respect to the refrigeration system 101b, in the refrigeration system 101c having the above construction, it can be surely grasped that safety can be secured without stopping the respective operations of the outdoor unit 110 and the first pump 130 even when any one of the flow switches 132a, 132b, 132c detects abnormality of the third pump 136. Therefore, even when at least any one of the flow switches 132a, 132b, 132c detects abnormality of the third pump 136, it is unnecessary to stop the operation of the outdoor unit 110 and the operation of the third pump 136.

In view of the foregoing description, according to this embodiment, a second function is applied to a refrigeration system in which plural chiller units are connected to the outdoor unit through the refrigerant pipe in parallel and also a single-system water medium pipe is provided. The second function is a function (mode) in which the operation of the outdoor unit and the operation of the pump are not stopped when at least one of the flow switches (except for all the flow switches) provided to the plural chiller units of the refrigeration system detects abnormality of the pump, and the operation of the outdoor unit and the operation of the pump are stopped when all the flow switches detect abnormality of the pump. As described above, in the case of the refrigeration system having the single-system water medium pipe, it can be surely grasped by the worker or the like that safety can be secured without stopping the operations of the outdoor unit and the pump even when any one of the plural switches detects abnormality of the pump, and thus the second function can be effectively applied to this refrigeration system. When the second function is applied to the refrigeration system 101b of this embodiment, when at least any one (except for all, i.e., three) of the flow switches 132a, 132b, 132c of the chiller units 111a, 111b, 111c detects abnormality of the third pump 136, the operation of the outdoor unit 110 and the operation of the third pump 136 are continued under the state that safety is secured, and when all the flow switches 132a, 132b, 132c detects abnormality of the third pump 136, the operation of the outdoor unit and the operation of the third pump 136 are stopped.

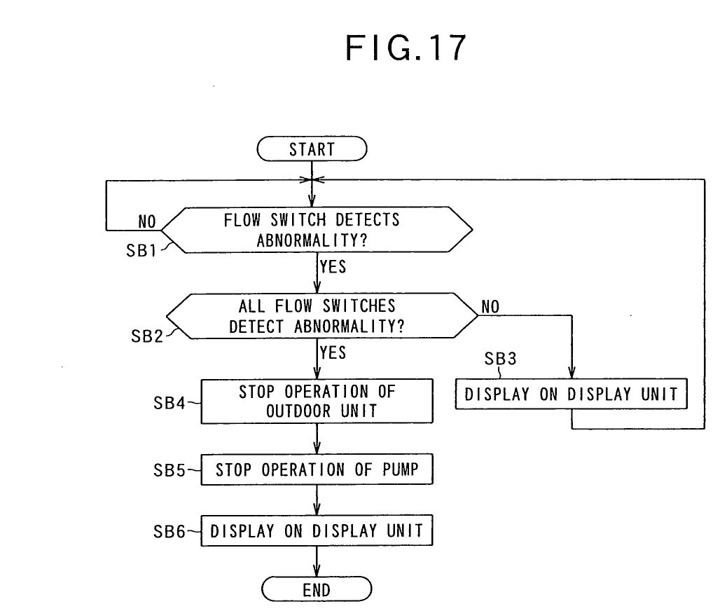

Next, the operation of the refrigeration system 1b to which the second function is applied will be described with reference to the flowchart of FIG. 17.

The outdoor controller 120 transmits a control signal to the chiller controllers 121a, 121b, 121c which are connected to the outdoor controller 120 through the communication line 122 so that communications can be performed between the outdoor controller 120 and the chiller controllers 121a, 121b, 121c, and monitors whether at least any one or all of the flow switches 132a, 132b, 132c controlled by the chiller controllers 121a, 121b, 121c detect abnormality of the third pump 136 (step SB1) When at least any one or all of the flow switches 132a, 132b, 132c detect abnormality of the third pump 136 (step SB1: YES), the outdoor controller 120 determines whether all of the flow switchers 132a, 132b, 132c detect abnormality of the third pump 136 or not (step SB2). When all the flow switches 132a, 132b, 132c do not detect abnormality of the third pump 36 (step SB2: NO), the outdoor controller 120 displays on the display unit 119 which flow switch out of the flow switches 132a, 132b, 132c detects abnormality of the third pump 36, and also displays it on the display unit 119 that the operation of the outdoor unit 110 and the operation of the third pump 136 are continued (step SB3). Accordingly, the worker or the like can easily and quickly recognizes that at least any one flow switch (except for all flow switches) out of the flow switches 132a, 132b, 132c detects abnormality of the third pump 136 and also under this state the outdoor unit 110 and the third pump 136 are operated, and can perform works of checking the operation of the flow switch, etc. on the basis of the recognition. After the display on the display unit 119, the outdoor controller 120 returns the processing flow to the step SB1. Accordingly, even when at least any one of the flow switches 132a, 132b, 132c detects abnormality of the third pump 136, the operation of the outdoor unit 110 and the operation of the third pump 136 are not stopped if all the flow switches 132a, 132b, 132c do not detect abnormality.

On the other hand, when all the flow switches 132a, 132b, 132c detect abnormality of the third pump 136 (step SB2: YES), the outdoor controller 120 controls the operation of the compressor 116 to stop the operation of the outdoor unit 110 (step SB4), and further stops the operation of the third pump 136 (step SB5). Subsequently, the outdoor controller 120 displays it on the display unit 119 that all the flow switches 132a, 132b, 132c detect abnormality and also the operation of the outdoor unit 110 and the operation of the third pump 136 are stopped (step SB6). Accordingly, the worker or the like can easily and quickly recognize that the operation of the outdoor unit 110 and the operation of the third pump 136 are stopped, and also easily and quickly recognize that abnormality occurs in the third pup 136. Therefore, the worker or the like can efficiently perform the work on the basis of this recognition.

In this embodiment, the outdoor controller 120 of the outdoor unit 110 has a third function (mode) for performing the switching operation between the first function and the second function in accordance with the connection style of the water medium pipe 114 (that is, the water medium pipe 114 of the single system or the water medium pipes 114 of plural systems). Specifically, a switch 120a such as a DIP switch or the like is provided on a circuit board of the outdoor controller 120, and by operating this switch 120a, the worker or the like can alternatively and easily select one of the first function and the second function to be applied in accordance with the situation that the refrigeration system has the water medium pipe 114 as a single system or the water medium pipes 114 as plural systems. The outdoor controller 120 has a first program for executing the first function shown in FIG. 14 and a second program for executing the second function shown in FIG. 17, and when the first function is selected by the switch 120a, the first program is executed, and when the second function is selected by the switch 120a, the second program is executed.

Here, it is not determined at the factory shipment time of each equipment of the refrigeration system whether the single-system water medium pipe 114 should be selected or the multi-system water medium pipe 114 should be selected, and it is determined through an on-site work. However, according to this embodiment, after the water medium pipe(s) 114 are actually laid down at the scene, the worker or the like can easily switch the first function and the second function to each other by using the third function in accordance with whether the laid-down water medium pipe 114 is based on the single system or the multi-system, and thus the installing work of the refrigeration system can be readily performed.

For example, when the water medium pipes of plural systems are provided as in the case of the refrigeration system 101a, the worker or the like operates the switch 120a to select the first function. At this time, the outdoor controller 120 and the chiller controllers 121a, 121b, 121c connected to the outdoor controller 20 execute the operations associated with the first function shown in the flowchart of FIG. 14. Furthermore, when the single-system water medium pipe 114 is laid down as in the case of the refrigeration system 101b or the refrigeration system 101c, the worker or the like operates the switch 120a to select the second function. At this time, the outdoor controller 20 and the chiller controllers 121a, 121b, 121c connected to the outdoor controller 120 executes the operations associated with the second function shown in the flowchart of FIG. 17.

Furthermore, the outdoor controller 120 of the outdoor unit 110 cooperates with the chiller controllers 121a, 121b, 121c of the chiller units 111a, 111b, 111c to execute the overall control of the refrigeration system, and thus the outdoor controller 120 is connected to the chiller controllers 121a, 121b, 121c so that communications can be performed between the outdoor controller 120 and each of the chiller controllers 121a, 121b, 121c through the communication line 122. In this embodiment, the third function is provided to the outdoor controller 120. Accordingly, when the worker or the like alternatively selects the first function or the second function by using the third function, a control signal is transmitted to the chiller controllers 121a, 121b, 121c of the respective chiller units 111a, 111b, 111c through this existing communication line 122, and each of the chiller controllers 121a, 121b, 121c executes the operation corresponding to the first function or second function on the basis of this control signal. Accordingly, it is unnecessary to execute an electrical wiring work or the like for laying down a new communication lines between the outdoor controller 120 and each of the chiller controllers 121a, 121b, 121c in order to execute the first function or the second function, and thus the installing work of the refrigeration system can be simply performed. Furthermore, the first function and the second function can be switched to each other by using the third function provided to the outdoor controller 120 of the outdoor unit 110. Therefore, even when the construction of the refrigeration system is changed (for example, when the single-system water medium pipe 114 is changed to the multi-system water medium pipes 114) or a new refrigeration system is constructed, the worker or the like can easily perform the switching operation between the first and second functions by using the third function provided to the outdoor controller 120.

As described above, according to this embodiment the outdoor controller 20 is provided with the first function which is applied to the refrigeration system 101a having the plural-system(multi-system) water medium pipes 114 and in which the outdoor unit 110 is stopped when any of the flow switches 132a, 132b, 132c operates, the second function which is applied to the refrigeration system 101b having the single-system water medium pipe 114 and in which the outdoor unit 110 is stopped when all the flow switches operate, and the third function for alternatively selecting one of the first and second functions. Therefore, the worker or the like can easily and alternatively select one of the first function and the second function as the function to be applied in accordance with the system type of the water medium pipe 114 (i.e., the single-system water medium pipe or the multi-system water medium pipes) at the scene by using the third function after the water medium pipe(s) 114 is laid down. Here, the system type of the water medium pipe 114 cannot be determined at the factory shipment time of each equipment of the refrigeration system, and it must be determined at the scene. However, according to this embodiment, by using the third function, one of the first and second functions can be freely selected in accordance with the system type (single-system type or multi-system type), so that the installation work of the refrigeration system can be simply performed.

Furthermore, in this embodiment, the third function is provided to the outdoor controller 120. Therefore, by using the third function, when the worker alternatively selects the first function or the second function, the control signal is transmitted to the chiller controllers 121a, 121b, 121c of the respective chiller units 111a, 111b, 111c through the existing communication line 122, and each of the chiller controllers 121a, 121b, 121c executes the operation corresponding to the first function or the second function on the basis of this control signal. Accordingly, it is unnecessary to execute an electrical wiring work or the like for laying down a new communication lines between the outdoor controller 120 and each of the chiller controllers 121a, 121b, 121c in order to execute the first function or the second function, and thus the installing work of the refrigeration system can be simply performed. Furthermore, the first function and the second function can be switched to each other by using the third function provided to the outdoor controller 120 of the outdoor unit 110. Therefore, even when the construction of the refrigeration system is changed (for example, when the single-system water medium pipe 114 is changed to the multi-system water medium pipes 114) or a new refrigeration system is constructed, the worker or the like can easily perform the switching operation between the first and second functions by using the third function provided to the outdoor controller 120.

In the above embodiment, the first and second functions are switched to each other by the DIP switch provided on the circuit board. However, the switching manner is not limited to the above embodiment. For example, when the outdoor unit 110 is provided with an operating unit for performing various kinds of setting such as setting of an operation mode, etc., the first and the second functions maybe switched to each other by operating this operating unit. Furthermore, the outdoor controller 120 may be connected to a terminal such as a personal computer or the like so that communications can be performed therebetween, and the first and second functions can be switched to each other by operating this connected terminal

Furthermore, the refrigeration systems 101a, 101b, 101c are described as examples of the refrigeration system. However, the construction of the refrigeration system is not limited to these examples, and various constructions may be adopted for the refrigeration system in accordance with the installation condition and functions required for the refrigeration system.

### Fourth Embodiment

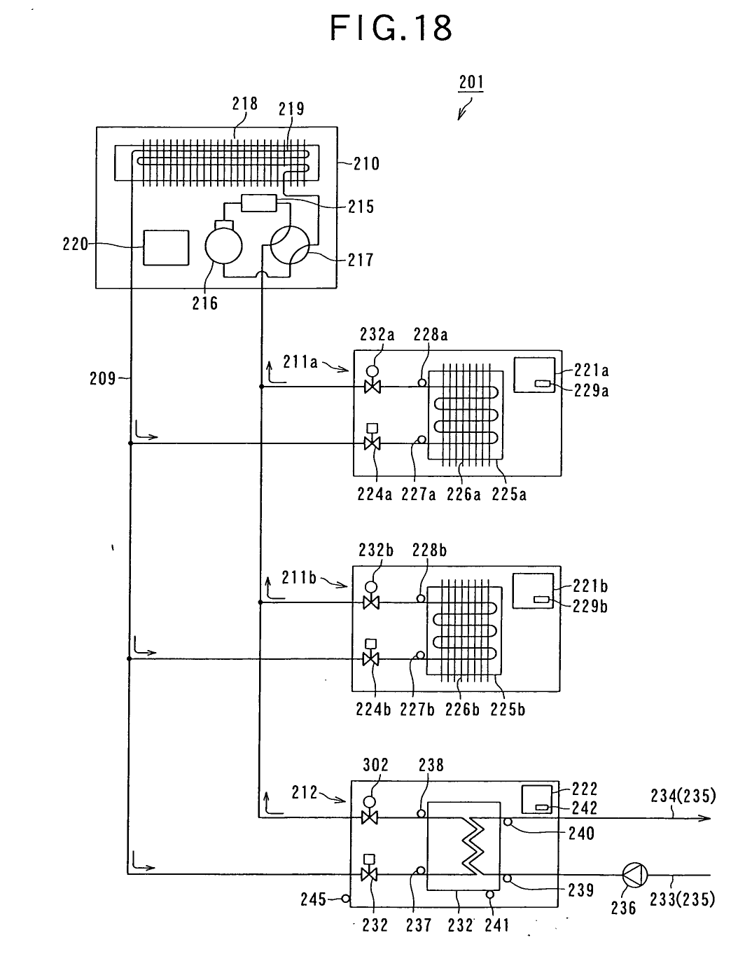

FIG. 18 is a schematic diagram showing the construction of the air conditioner 1 according to a fourth embodiment, and two direct-expansion indoor units are set in place of the two chiller units shown in FIG. 15.

As shown in FIG. 18, the air conditioner 201 has an outdoor unit 210, and two direct-expansion indoor units 211a and 211b and a chiller unit 212 are connected to the outdoor unit 210 through a refrigerant pipe 209 in parallel. In FIG. 18, a refrigerant circuit is under the state that the direct-expansion indoor units 211a and 211b carry out cooling operation and the chiller unit 212 generates cold water. In the following description, the air conditioner 201 under this state will be described.

As shown in FIG. 18, the outdoor unit 210 includes an accumulator 215 for separating refrigerant into gas refrigerant and liquid refrigerant and leading out only the gas refrigerant, a compressor 216 for setting the refrigerant sucked from the accumulator 215 to high-temperature and high-pressure refrigerant and then leading out the high-temperature and high-pressure refrigerant, a four-way valve 217 which is connected to the compressor 216 and changes the refrigerant circuit in accordance with cooling operation or heating operation, and an outdoor heat exchanger 218 for performing the heat-exchange between air and the refrigerant led out from the compressor 216 to liquefy the refrigerant and leading out the liquefied refrigerant. The outdoor heat exchanger 218 has a fin 219, and the efficiency of the heat exchange between the refrigerant and the air can be enhanced by this fin 219.

The outdoor unit 210 has an outdoor controller 220 for controlling respective equipment of the outdoor unit. The outdoor controller 220 is connected to indoor controllers 221a, 221b and a chiller controller 222 described later so that communications can be performed. These controllers cooperate with one another to control the overall air conditioner 210 such as adjustment of the operation level of the compressor 216, etc.

The direct-expansion indoor unit 211a has an opening/closing valve 232a which controls introduction or interruption of refrigerant into itself by opening/closing the valve, an expansion valve 224a for reducing the pressure of the refrigerant introduced from the outdoor heat exchanger 218 to obtain liquefied low-temperature and low-pressure refrigerant, and an indoor heat exchanger 225a for evaporating the refrigerant from the expansion valve 124a at a predetermined temperature to cool air. As shown in FIG. 18, the indoor heat exchanger 225a has fins 226a as shown in FIG. 18, and the efficiency of the heat exchange between refrigerant and air is enhanced by the fins 226a. The direct-expansion indoor unit 211a has an opening/closing valve 232a, and under heating operation, the opening/closing valve 232a operates to interrupt introduction of the refrigerant into the direct-expansion indoor unit 211a.

Indoor refrigerant temperature sensors 227a and 228a for detecting the temperature of refrigerant are provided in the neighborhood of the indoor heat exchanger 225a, and the temperature of refrigerant introduced into the indoor heat exchanger 225a is detected by the indoor refrigerant temperature sensors 227a and 228a.

Furthermore, the direct-expansion indoor unit 211a has an indoor controller 221a for controlling respective equipment provided to the direct-expansion indoor unit 211a. The indoor controller 221a is connected to the indoor refrigerant temperature sensors 227a and 228a so that communication can be performed therebetween. The temperature of refrigerant introduced into the indoor heat exchanger 225a is detected on the basis of the output values of the indoor refrigerant temperature sensors 227a and 228a. Furthermore, as described above, the indoor controller 221a and the outdoor controller 220 are connected to each other so as to be able to communicate with each other, and the indoor controller 221a can output a signal representing the detected temperature of the refrigerant to the outdoor controller 220 and also outputs a signal representing the status thereof such as the opening/closing state of the opening/closing valve 232a or the like to the outdoor controller 220.

Furthermore, the indoor controller 221a has a time counter 229a for executing various kinds of time counting operations on the basis of a reference clock generated by an oscillator (not shown).

Here, the direct-expansion indoor unit 211a has the fins 226a. When drain adhering to the fins 226a under cooling operation is frozen, the frozen drain disturbs flow of air through the fins 226a and thus the efficient heat exchange is disturbed. In order to prevent this trouble, the indoor controller 221a according to this embodiment executes the following control. Here, a temperature at which drain may be possibly frozen is represented by To (drain freezing temperature). In this embodiment, To is set to 2° C. When the indoor controller 221a determines on the basis of the temperature of the refrigerant detected by the indoor refrigerant temperature sensor 228a that a state at To or less is continued for 10 minutes, the indoor controller 221a sets the expansion valve 224a to a close state to interrupt the introduction of refrigerant because drain would be frozen if this state is further continued. Accordingly, drain adhering to the fins 226a is prevented from being further cooled and thus from being frozen. Here, the operation of setting the expansion valve to the close state and interrupting the introduction of refrigerant is referred to as “thermo-off”). In the following description, the function of making the direct-expansion indoor unit 211a execute “thermo-off” when the temperature of refrigerant reaches a temperature at which drain occurs (drain freezing temperature) is referred to as “first function”.

As described above, in the first function, when the direct-expansion indoor unit 211a determines whether the thermo-off is executed to prevent freeze of drain, it executes not only detection of the temperature of the refrigerant, but also determination as to whether the temperature of the refrigerant is continued for a predetermined time or not. This is because when the determination as to the thermo-off is executed on the basis of only the temperature of the refrigerant (for example, the thermo-off is executed when the temperature of the refrigerant is reduced to 2° C. or less), the freeze of the drain can be surely prevented, however, there is a problem that the thermo-off occurs frequently. This is because the size of a room to be air-conditioned in which the direct-expansion indoor unit 211a is installed is not uniform, and also the set temperature of the room to be air-conditioned is changed on a case-by-case basis by a user, and thus it is not rare that the air-conditioning load imposed on the direct-expansion indoor unit 211a increases drastically. Furthermore, when the air-conditioning load increases, the amount of refrigerant introduced into the direct-expansion indoor unit 211a is increased by increasing the operation level of the compressor 216 of the outdoor unit 210. At this time, the temperature of the refrigerant introduced into the indoor heat exchanger 225a temporarily decreases to 2° C. or less. Furthermore, if the required load of the chiller units connected to the outdoor unit 210 in parallel increases, the circulation amount of refrigerant increases even when the load of the direct-expansion indoor unit 211a is small. In this case, a lot of refrigerant flows into the direct-expansion indoor unit, and the temperature of refrigerant introduced into the indoor heat exchanger 225a temporarily decreases to 2° C. or less.

In view of this phenomenon, according to this embodiment, even when the temperature of the refrigerant is equal to or less than 2° C., but this state is not continued for 10 minutes or more, the probability that drain is frozen is extremely low. Therefore, thermo-off is set only when the state that the temperature of the refrigerant is equal to or less than 2° C. is continued for 10 minutes, whereby the thermo-off is prevented from occurring frequently with preventing freeze of drain, so that the air-conditioning operation can be smoothly performed.

The direct-expansion indoor unit 211b has substantially the same construction as the direct-expansion indoor unit 211a, and it has an indoor controller 221b, an opening/closing valve 232b, an expansion valve 224b, an indoor heat exchanger 225b, fins 226b, an indoor refrigerant temperature sensor 228b, etc.

The chiller unit 212 has an opening/closing valve 302 for controlling introduction/interruption of refrigerant into/from itself by opening/closing the valve, an expansion valve 231 for reducing the pressure of refrigerant introduced from the outdoor heat exchanger 218 to obtain liquefied low-temperature and low-pressure refrigerant, a plate type heat exchanger 232 for performing the heat-exchange between the refrigerant introduced from the expansion valve 231 and water to generate cold water (hot water when the direct-expansion indoor unit is under heating operation), a going pipe 233 through which water medium flowing into the plate type heat exchanger 232 flows and a returning pipe 234 through which water medium flowing out from the plate type heat exchanger 232 flows. A circulating pump 236 for making water medium flow through the water medium pipe 235 is provided in the going pipe 233 of the water medium pipe 235. The circulating pump 236 is connected to a chiller controller 222 (described later) so that communications can be performed therebetween, and start/stop of the operation of the circulating pump 236 is executed under the control of the chiller controller 222 or under the control of the outdoor controller 220 connected to the chiller controller 222. The chiller unit 212 has an opening/closing valve 302. Under heating operation, the opening/closing valve 302 operates, and the introduction of refrigerant into the chiller unit 212 is interrupted.

Chiller refrigerant temperature sensors 237 and 238 for detecting the temperature of the refrigerant are provided in the neighborhood of the plate type heat exchanger 232, and the temperature of the refrigerant to be introduced into the plate type heat exchanger 232 can be detected by the chiller refrigerant temperature sensors 237 and 238. A heat exchanger temperature sensor 241 is provided on the surface of the plate type heat exchanger 232, and the temperature of the surface of the plate type heat exchanger 232 can be detected by the heat exchanger temperature sensor 241.

The chiller unit 212 has a chiller controller 222 for controlling respective equipment of the chiller unit 212. The chiller controller 222 is connected to the chiller refrigerant temperature sensors 237 and 238, the chiller water medium temperature sensors 239 and 240 and the heat exchanger temperature sensor 241 so that signal communication can be performed. The indoor controller 221a detects the temperature of the refrigerant to be introduced into the plate type heat exchanger 232, the temperature of the water medium flowing out from the plate type heat exchanger 232 and the temperature of the surface of the plate type heat exchanger 232 on the basis of the output values of the respective sensors. As described above, the chiller controller 22 and the outdoor controller 220 are connected to each other so that communications can be performed therebetween, and the chiller controller 222 can transmit a signal representing the detected temperature of the refrigerant and signals representing the status thereof such as the opening/closing state of the opening/closing valve 302, etc. to the outdoor controller 220.

The chiller controller 222 has a time counter 242 for executing various kinds of time counting operations on the basis of a reference clock generated by an oscillator (not shown).

Here, the chiller unit 212 has a water medium pipe 235 unlike the direct-expansion indoor units 211a and 211b. When the chiller unit is continued to be operated to generate cold water under the state that the water medium flowing through the water medium pipe 235 is excessively cooled and thus frozen, the water medium pipe 235 or the circulating pump 236 may be damaged. In order to prevent this damage, the chiller controller 222 according to this embodiment executes thermo-off when any one of a first condition, a second condition and a third condition described below is satisfied, whereby freeze of the water medium is prevented and the water medium pipe 235 and the pump are prevented from being damaged.

That is, when the temperature of the water medium which is detected by the chiller water medium temperature sensors 239 and 240 is equal to or less than a temperature at which the water medium may be frozen (in this embodiment, “2° C. or less” (first condition), the chiller controller 222 executes thermo-off to stop further cooling of the water medium because the further cooling may cause the water medium to be frozen, thereby preventing freeze of the water medium.

In this embodiment, the chiller water medium temperature sensor 240 is provided at the exit side of the plate type heat exchanger 232. Here, the freeze of the water medium which is excessively cooled by the plate type heat exchanger 232 is successively started from the water medium at the flow-out side of the plate type heat exchanger 232. In this case, the chiller water medium temperature sensor 240 is provided at the exit side of the plate type heat exchanger 232, so that the freeze of the water medium can be quickly detected.

When the temperature of the plate type heat exchanger 232 detected by the heat exchanger temperature sensor 241q is equal to or less than the temperature at which the freeze of the water medium occurs (in this case, “2° C.” (second condition), the chiller controller 222 executes thermo-off because there is a risk that the freeze of the water medium cooled in the plate type heat exchanger 232 is frozen, whereby the water medium is prevented from being further cooled and thus the water medium is prevented from being frozen. In the following description, the function of executing thermo-off on the basis of the first condition and the second condition when the temperature of the water medium or the temperature of the heat exchanger reaches the temperature at which freeze of the water medium occurs (freeze estimation temperature) is referred to as “second function”.

In addition to the above conditions, the chiller controller 222 executes thermo-off when the same condition as the direct-expansion indoor units 211a and 211b, that is, the state that the temperature of the refrigerant detected by the chiller refrigerant temperature sensors 237 and 238 is equal to or less than the temperature at which freeze of water medium occurs (in this embodiment, “2° C.”) is continued for 10 minutes (third condition). That is, the chiller unit 212 has the first function described above. As described above, the chiller unit 212 executes thermo-off when any one of the first condition corresponding to a condition associated with the temperature of water medium, the second condition corresponding to a condition associated with the temperature of the plate type heat exchanger 232 and the third condition corresponding to a condition associated with the temperature of the refrigerant is satisfied, whereby all possible means is expanded to prevent freeze of water medium.

Here, in this embodiment, with respect to the condition associated with the temperature of the refrigerant, the third condition which is the same condition as the direct-expansion indoor units 211a, 211b is applied. The application of the third condition brings the following effect.

That is, in the case of a refrigeration machine in which the direct-expansion indoor units 211a and 211b do not exist and the indoor unit 210 and the chiller unit 212 are connected to each other in one-to-one correspondence, a condition (hereinafter referred to as “temporary condition”) that thermo-off is executed when the temperature of the refrigerant reaches the temperature inducing freeze of water medium (for example, minus 10° C.) may be applied in place of the third condition. By applying this condition, water medium can be prevented from being frozen due to the temperature of there frigerant. However, in the air conditioner 201 in which the direct-expansion indoor units 211a, 211b and the chiller unit 212 are connected to the outdoor unit 10 in parallel as in the case of this embodiment. The temperature of the refrigerant of the chiller unit 212 is temporarily reduced to minus 10° C. or less due to the state of the air conditioning load of the direct-expansion indoor units 211a, 211b or the state of thermo-on/thermo-off to no small extent. Therefore, when the above temporary condition is applied as the condition associated with the temperature of the refrigerant, there occurs such a situation that the chiller unit 212 executes thermo-off every time the temperature of the refrigerant is temporarily reduced to minus 10° C. or less.

Specifically, when a set temperature which is greatly different from the present temperature of a room to be air-conditioned in which the direct-expansion indoor unit 211a is installed is set for the direct-expansion indoor unit 211a or the like, the operation level of the compressor 216 is increased and a large amount of refrigerant is introduced into the indoor heat exchanger 225a of the direct-expansion indoor unit 211a under the control of the indoor controller 221a and the outdoor controller 220. At this time, a large amount of refrigerant is also introduced into the chiller unit 212 connected to the outdoor unit 120 in parallel, and thus the temperature of the refrigerant in the chiller unit 212 may be temporarily reduced to minus 10° C. or less. In addition, the direct-expansion indoor unit 211a executes thermo-off to stop further cooling operation when the temperature of the room to be air-conditioned in which the direct-expansion indoor unit 211a is installed reaches a desired set temperature or when the cooling operation is stopped on the basis of a user's instruction or the like. In this case, refrigerant which is determined to be introduced into the direct-expansion indoor unit 211a is introduced into the chiller unit 212 connected to the outdoor unit 210 in parallel, so that the temperature of the refrigerant in the chiller unit 212 is temporarily reduced to minus 10° C. or less.

In view of the foregoing situation, according to this embodiment, in order to prevent the situation that the temperature of the refrigerant in the chiller unit 12 is temporarily reduced to minus 10° C. or less and thus the direct-expansion indoor units 211a, 211b frequently executes thermo-off, the above temporary condition is not applied, but the third condition which is the same condition as applied to the direct-expansion indoor units 211a, 211b is applied as the condition associated with the temperature of the refrigerant. As described above, freeze of drain is prevented by applying the third condition in the direct-expansion indoor units 211a, 211b. However, the drain and the water medium are the same water, and thus the temperature at which icing or freezing occurs is not different therebetween. Accordingly, the third condition can be effectively used as the condition for preventing the freeze of the water medium in place of the icing of the drain. Furthermore, as described above, in the direct-expansion indoor units 211a, 211b, not only the temperature of refrigerant is detected, but also it is determined whether the temperature of the refrigerant is continued for a predetermined time in the third condition, whereby thermo-off is prevented from being executed frequently. By applying the third condition in the chiller device 212, thermo-off can be likewise prevented from being frequently executed in the chiller device 212.

The chiller unit 212 of the air conditioner 201 of this embodiment has an outside air temperature sensor 245 for measuring the temperature of the outside air. The outside air temperature sensor 245 is connected to the chiller controller 222 so that communications can be performed therebetween, and the chiller controller 222 can detect the temperature of the outside air on the basis of the output value of the outside air temperature sensor 245. When the temperature of the outside air detected by the outside air temperature sensor 245 is equal to the temperature at which freeze of water medium in the water medium pipe 235 occurs (in this embodiment, “2° C.”) and also the chiller unit 212 is not operated and thus the circulating pump 236 is not operated, the chiller controller 222 transmits an operation signal to the circulating pump 236 to start the operation of the circulating pump 236. Accordingly, the water medium in the water medium pipe 235 flows, and thus the water medium in the water medium pipe 235 is prevented from being frozen by the outside air. In the following description, the function that the operation of the circulating pump 236 is started when the outside air temperature reaches the temperature at which freeze of water medium occurs under the operation-stopped state of the chiller unit 212 is referred to as “third function”.

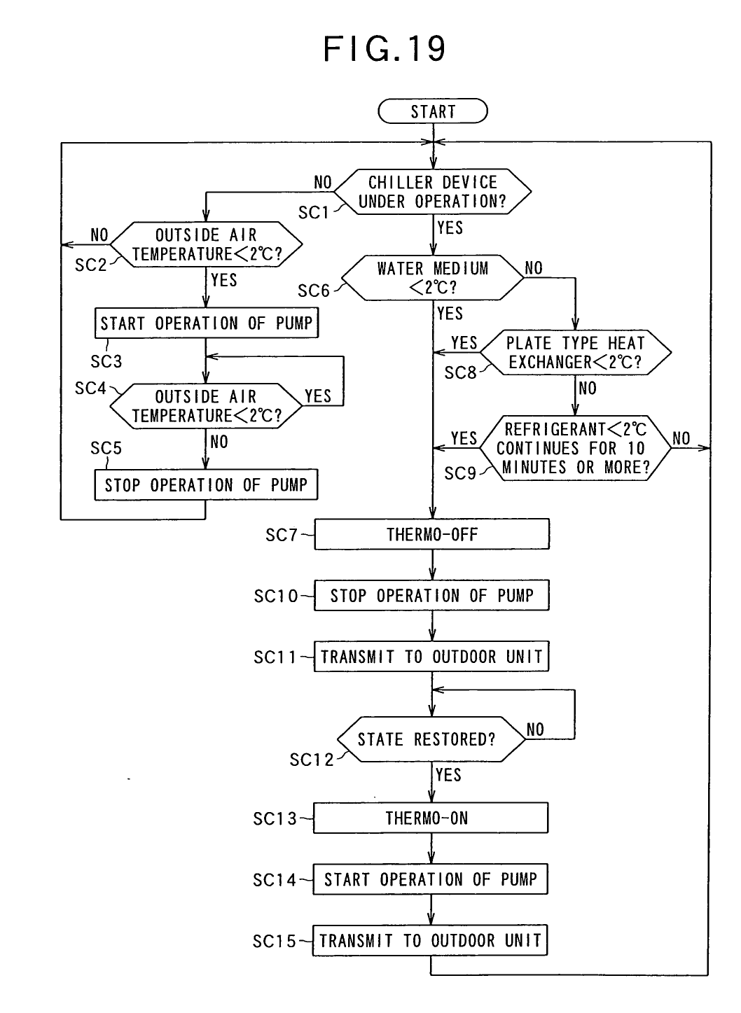

Next, the operation of the chiller unit 212 when cold water is generated will be described with reference to the flowchart of FIG. 19.

First, in step SC1, the chiller controller 222 of the chiller unit 212 determines whether the chiller unit 212 is under operation or not at present, that is, whether the circulating pump 236 is operated to circulate water medium and generate cold water. If the chiller device 212 is not under operation (step SC1: NO), the chiller controller 222 determines on the basis of the output value of the outside air temperature sensor 245 whether the outside air temperature is lower than the temperature at which freeze of water medium in the water medium pipe 235 occurs (in this embodiment, “2° C.”) (step SC2). If the outside air temperature is not lower than 2° C. (step SC2: NO)<the chiller controller 222 returns the processing to the step SC1. If the outside air temperature is lower than 2° C. (step SC2: YES), the chiller controller 222 transmits an operation signal to the circulating pump 236 to start the operation of the circulating pump 236 so that the freeze of the water medium in the water medium pipe 235 by the outside air is prevented (step SC3) Thereafter, the chiller controller 222 monitors whether the outside air temperature is lower than 2° C. (step SC4) If the outside air temperature is not lower than 2° C. (step SC4: NO), the operation of the circulating pump 236 is stopped (step SC10). After the operation of the circulating pump 236 is stopped, the chiller controller 222 returns the processing to the step SC1.

On the other hand, in step SC1, when the chiller unit 212 is under operation (step SC1: YES), the chiller controller 222 determines whether the first condition described above is satisfied, that is, the temperature of the water medium reaches the freezing-assumed temperature (in this embodiment, “2° C.”) (step SC6). When the temperature of the water medium is lower than 2° C. (step SC6: YES), the chiller controller 222 shifts the processing to step SC7 in order to prevent the water medium from being frozen. When the temperature of the water medium is not less than 2° C. (step SC6: NO), the chiller controller 222 determines whether the second condition is satisfied, that is, the temperature of the plate type heat exchanger 232 is lower than the freeze-assumed temperature of the water medium (in this embodiment, “2° C.”) (step SC8). When the plate type heat exchanger 232 is lower than 2° C. (step SC8: YES), the chiller controller 222 shifts the processing to the step SC7 in order to prevent freeze of the water medium. When the temperature of the plate type heat exchanger 232 is not less than 2° C. (step SC8: NO), the chiller controller 222 determines whether the third condition is satisfied, that is, the state that the temperature of the refrigerant is lower than the temperature at which the water medium is frozen (in this embodiment, “2° C.”) is continued for 10 minutes (step SC9). When the state that the refrigerant temperature is lower than 2° C. is continued for 10 minutes (step SC9: YES), the chiller controller 222 shifts the processing to the step SC7 to prevent the freeze of the water medium. When the state that the temperature of the water medium is lower than 2° C. is not continued for 10 minutes (step SC9: NO), the chiller controller 222 returns the processing to the step SC1, and determines again whether the water medium is frozen or not.

In step SC7, in order to prevent the freeze of water medium, the chiller controller 222 executes thermo-off and stops further cooling of the water medium, thereby preventing the freeze of the water medium. Then, the chiller controller 222 stops the operation of the pump to avoid the situation that the circulating pump 236 is operated under the state that the water medium is frozen and thus the circulating pump 236 and the water medium pipe 235 are damaged (step SC10). Thereafter, the chiller controller 222 outputs the signal representing the temperature of the water medium, the temperature of the plate type heat exchanger, the temperature of the refrigerant and the driving status of the circulating pump 236 to the outdoor controller 220. The outdoor controller 220 can control the operation of the compressor 216 and the direct-expansion indoor units 211a and 211b on the basis of the signal.

Subsequently, the chiller controller 222 determines whether each of the first, second and third conditions is not satisfied, specifically, monitors whether the temperature of the water medium is not less than 2° C., the temperature of the plate type heat exchanger 232 is not less than 2° C. and also the temperature of the refrigerant is not less than 2° C., thereby determining whether thermo-on is possible or not (step SC12). When thermo-on is possible (step SC12: YES), the chiller controller 222 executes thermo-on (step SC13), and also starts the operation of the circulating pump 236 (step SC14) to restart generation of cold water. Then, the chiller controller 222 outputs the signal representing the temperature of the water medium, the temperature of the plate type heat exchanger, the temperature of the refrigerant and the operation state of the circulating pump 236 to the outdoor controller 220. On the basis of the signal concerned, the outdoor controller 220 can control the operation of the compressor 216 and the direct-expansion indoor units 211a and 211b.

As described above, according to this embodiment, the direct-expansion indoor units 211a and 211b have the first function in which the direct-expansion indoor units 211a and 211b execute thermo-off when the temperature of the refrigerant reaches the temperature of icing of drain occurs. The chiller unit 212 has this first function and also has the second function in which it executes thermo-off when the temperature of the water medium or the temperature of the heat exchanger reaches the temperature at which freeze of water medium occurs (freeze-assumed temperature).

With this construction, icing of drain in the direct-expansion indoor units 211a and 211b can be prevented, the reduction of the air flow amount can be prevented, and the smooth air-conditioning operation can be performed. Furthermore, the condition of preventing the icing of drain can be effectively used as the condition of preventing the freeze of the water medium, and thus the freeze of the water medium in the chiller unit 212 can be prevented by the first function. Still furthermore, the freeze of the water medium in the chiller device 212 can be prevented by the second function.

Furthermore, in the above embodiment, the chiller unit 212 has the third function in which the operation of the circulating pump 236 is started when the outside air temperature reaches the temperature at which freeze of water medium occurs under the operation-stopped state of the chiller device 212. Therefore, cold water can be prevented from being frozen by the outside air.

The present invention is not limited to the above embodiment, and various modifications and applications may be freely made without departing from the subject matter of the present invention.

In the above embodiment, the chiller controller 222 controls the circulating pump 236, determines thermo-off of the chiller unit 212, etc. However, these functions may be implemented by the outdoor controller 220 which is connected to the chiller controller 222 so that communications can be performed therebetween.

What is claimed is:

1. A chiller unit comprising:
a chiller unit main body connected to a refrigeration cycle;
a plate type heat exchanger unit that is secured to an upper stage portion of the chiller unit main body and divided into plural plate type heat exchangers; and
a pipe group having a water medium pipe and a refrigerant pipe for supplying water medium and refrigerant to each of the plate type heat exchangers while branching the water medium and the refrigerant and collectively disposed at a lower stage portion of the chiller unit main body, wherein at least an exit side portion of the water medium pipe is routed substantially horizontally along the bottom portion of the chiller unit main body and a flow switch is provided in a horizontally-extending pipe portion of the water medium pipe.

2. The chiller unit according to claim 1, wherein the substantially horizontally extending pipe portion is fixed to the bottom portion of the chiller unit main body through a fixing member, and the flow switch is provided to the pipe portion in the neighborhood of the fixing member.

3. The chiller unit according to claim 1, wherein the chiller unit main body has a support table substantially at the center portion in the height direction thereof, and the plate type heat exchangers are mounted to side portions of the chiller unit main body through support plates.

4. The chiller unit according to claim 1, wherein the respective plate type heat exchangers are secured to the confronting side portions of the chiller unit main body so that an overall weight balance of the chiller unit main body is kept.

5. The chiller unit according to claim 1, wherein the flow switch comprises a paddle type flow switch having a paddle extending in a direction perpendicular to the flow direction of the water medium in the pipe portion.

6. A refrigeration system comprising:
an outdoor unit;
plural chiller units which are connected to the outdoor unit in parallel and supplied with refrigerant through a refrigerant pipe and with water medium through at least single-system water medium pipe, each of the chiller units having a flow switch;
a first unit for stopping the outdoor unit when at least one of the flow switches operates in the case where the plural chiller units are grouped into plural systems and connected to water medium pipes of plural systems;
a second unit for stopping the outdoor unit when all the flow switches operate in the case where the chiller unit is connected to a single-system water medium pipe; and
a selecting unit for alternatively selecting one of the first unit and the second unit on the basis of the connection relationship between the chiller unit and the water medium pipe.

7. The refrigeration system according to claim 6, wherein the first unit, the second unit and the selecting unit are provided to a controller for controlling the outdoor unit.

8. The refrigeration system according to claim 7, wherein the controller of the outdoor unit is connected to respective controllers of the plural chiller units through a communication line, and when any one of the first unit and the second unit is selected by the selecting unit, the controller of the outdoor controller cooperates with the controllers of the chiller units to make the selected means execute.

9. An air conditioner having an outdoor unit, a chiller unit having a heat exchanger which is supplied with refrigerant from the outdoor unit through a refrigerant pipe and also supplied with water medium through a water medium pipe, and a direct-expansion indoor unit supplied with the refrigerant from the outdoor unit through the refrigerant pipe, the chiller unit and the direct-expansion indoor unit being connected to the outdoor unit through the refrigerant pipe in parallel, wherein the direct-expansion indoor unit has a first thermo-off unit for executing thermo-off on the direct-expansion indoor unit when the temperature of refrigerant flowing through the direct-expansion indoor unit reaches an icing temperature of drain, and the chiller unit has a second thermo-off unit for executing thermo-off on the chiller unit when any one of the temperature of the water medium flowing through the chiller unit, the temperature of the refrigerant flowing through the chiller unit and the temperature of the heat exchanger reaches a freeze-assumed temperature of water.

10. The air conditioner according to claim 9, wherein the first thermo-off unit executes thermo-off on the direct-expansion indoor unit when the state that the temperature of the refrigerant is less than the icing temperature or less is continued for a predetermined time.

11. The air conditioner according to claim 9, wherein the first thermo-off unit has an indoor refrigerant temperature sensor for detecting the temperature of the refrigerant.

12. The air conditioner according to claim 9, wherein the second thermo-off unit has a chiller refrigerant temperature sensor for detecting the temperature of the refrigerant, a chiller water medium temperature sensor for detecting the temperature of the water medium, a heat exchanger temperature sensor for detecting the surface temperature of the heat exchanger, and an outside air temperature sensor for detecting the outside air temperature.

13. The air conditioner according to claim 9, wherein the air conditioner further has a circulating pump for supplying water medium to the chiller unit, and a unit for instructing to start the operation of the circulating pump when the outside air temperature reaches a freeze-assumed temperature.
